(19) United States
(12) Patent Application Publication
(10) Pub. No.: US 2013/0168441 A1
(43) Pub. Date: Jul. 4, 2013

(54) ARTICLE AND METHODS FOR PREPARING AN OBJECT FOR STERILIZATION

(71) Applicant: 3M INNOVATIVE PROPERTIES COMPANY, St. Paul, MN (US)

(72) Inventors: Kevin D. Landgrebe, Woodbury, MN (US); Heather M. Webb, Woodbury, MN (US); Bernard A. Gonzalez, St. Paul, MN (US); Timothy J. Nies, Stillwater, MN (US); Peter J. Molitor, St. Paul, MN (US); Patricia S. Columbus-Powers, St. Paul, MN (US); Michael J. Fletcher, White Bear, MN (US)

(73) Assignee: 3M INNOVATIVE PROPERTIES COMPANY, ST. PAUL, MN (US)

(21) Appl. No.: 13/681,056

(22) Filed: Nov. 19, 2012

Related U.S. Application Data
(60) Provisional application No. 61/581,816, filed on Dec. 30, 2011.

(51) Int. Cl. B65D 25/14; B31B 7/00

(52) U.S. Cl. CPC B65D 25/14; B31B 7/00
USPC 229/117.27; 493/100

(57) ABSTRACT

A foldable shell having a plurality of panels and at least one flap is provided. The shell has a substantially planar unfolded state and a first folded state that defines a container suitable to hold an object to be sterilized. Optionally, the foldable shell may have a liner attached thereto. A method of folding a foldable shell and a liner to prepare an object for sterilization is also provided. The method results in the formation of the container while simultaneously enfolding the liner around an object disposed on the foldable shell.

### CROSS REFERENCE TO RELATED APPLICATIONS

This application claims the benefit of U.S. Provisional Patent Application No. 61/581,816, filed Dec. 30, 2011, which is incorporated herein by reference in its entirety.

### BACKGROUND

A variety of products and articles, including, for example, medical instruments, devices, and equipment, must be sterilized prior to use to prevent bio-contamination of a wound site, a sample, an organism, or the like. Sterilization of items used in medical procedures is vital to minimizing the spread of harmful and infectious agents to patients. Typically, the items used in medical procedures are placed into a container and wrapped with a flexible wrap (e.g., a cloth or sheet) made of a gas-permeable material or the items are placed into a reusable vented rigid container. The sterilization containers are typically designed to preserve sterility of the items contained therein, as well as the interior portion of the containers, after the containers and contents of the container have been subjected to a sterilization procedure. Examples of gases used to sterilize objects include steam, ethylene oxide, hydrogen peroxide, gas plasma, ozone, peracetic acid and the like.

Modern surgical procedures (e.g., to implant an orthopedic prosthetic device, such as an artificial hip) have led to the development of specialized kits containing all of the instruments and devices needed for the surgery. Typically, the instruments and devices are loaded into a single metal tray, which is sterilized at the hospital before use. The trays are often loaded into metal cases for easy handling before and after the sterilization process. However, the combined weight of the instrument trays plus the metal sterilization case could result in a filled container that weighs nearly 40 pounds. This is impractical and detrimental for workers to handle repeatedly throughout the work day. Many hospitals are now enforcing guidelines restricting the weight of sterilization packages.

Flexible sterilization wraps provide a lighter alternative to the use of containers. Unlike rigid containers, however, sterilization wraps may be particularly susceptible to punctures or other failures during storage, transit, and/or handling.

It is equally important that sterilized packages are easily and aseptically opened in the surgical suite or other final locations of use.

In spite of the advancements in the development of new systems for wrapping and protecting instruments and devices to be sterilized, there remains a need for improved articles and methods to prepare an object for sterilization and to protect the object thereafter.

### SUMMARY

In general, the present disclosure relates to an article and methods for preparing an object to be sterilized. The article comprises a foldable shell, optionally, with a liner attached thereto. The article and liner can be used in a method to form a container around an object to be sterilized. While forming the container, the object is simultaneously wrapped with the liner and the liner is secured around the object without having to use additional secural means to secure the liner around the object.

In one aspect, the present disclosure provides a method. The method can comprise positioning a liner that is substantially impermeable to microorganisms on a foldable shell, wherein the foldable shell has an unfolded state and a first folded state that defines a container, the container defining an inner volume having a first 3-dimensional shape; wherein the foldable shell comprises a plurality of panels that includes a bottom panel and three or more sidewall panels, the three or more sidewall panels each being hingedly connected to the bottom panel; wherein positioning the liner comprises positioning the liner so that the liner superimposes the bottom panel. The method further can comprise placing an object onto a portion of the liner that superimposes the bottom panel, wherein the object has an exterior surface that defines a second 3-dimensional shape that can be wholly contained within the first 3-dimensional shape. The method further can comprise forming the container by folding the shell at a plurality of predetermined fold loci, wherein folding the shell causes the object to be enveloped by the container and the liner. In any embodiment, the foldable shell further can comprise at least one flap that is hingedly connected to one of the three or more sidewall panels, wherein forming the container comprises positioning the at least one flap so that it superimposes a portion of one of the plurality of panels.

In any of the above embodiments, the bottom panel can have a bottom panel area circumscribed by a bottom panel first edge, a bottom panel second edge, a bottom panel third edge, and a bottom panel fourth edge. The three or more wall panels can comprise a first sidewall panel having a first sidewall panel area circumscribed by a first sidewall panel first edge, a first sidewall panel second edge, a first sidewall panel third edge, and a first sidewall panel fourth edge, wherein the first sidewall panel first edge is foldably connected to the bottom panel first edge at a first hinge region, wherein the first sidewall panel third edge is foldably connected to a top wall panel at a second hinge region; a second sidewall panel having a second sidewall panel area circumscribed by a second sidewall panel first edge, a second sidewall panel second edge, a second sidewall panel third edge, and a second sidewall panel fourth edge, wherein the second sidewall panel first edge is foldably connected to the bottom panel second edge at a third hinge region, wherein the second sidewall panel third edge is foldably connected to a first flap at a fourth hinge region; a third sidewall panel having a third sidewall panel area circumscribed by a third sidewall panel first edge, a third sidewall panel second edge, a third sidewall panel third edge, and a third sidewall panel fourth edge, wherein the third sidewall panel first edge is foldably connected to the bottom panel third edge at a fifth hinge region, wherein the third sidewall panel third edge is foldably connected to a second flap at a sixth hinge region; and a fourth sidewall panel having a fourth sidewall panel area circumscribed by a fourth sidewall panel first edge, a fourth sidewall panel second edge, a fourth sidewall panel third edge, and a fourth sidewall panel fourth edge, wherein the fourth sidewall panel first edge is foldably connected to the bottom panel fourth edge at a seventh hinge region, wherein the fourth sidewall panel third edge is foldably connected to a third flap at an eighth hinge region. In the unfolded state, the bottom panel, the first sidewall panel, the second sidewall panel, the third sidewall panel, the fourth sidewall panel, and the top wall panel of the foldable shell collectively define a first area. Forming the container can comprise sequentially folding the shell at each of the first through eighth hinge regions to form the container with the object enclosed therein. After forming the container, a portion of the top wall panel is positioned between the first flap and the object, a portion of the top wall panel is positioned between the second flap and the object, and a portion of the top wall panel is positioned between the third flap and the object.

In any of the above embodiments, sequentially folding the shell at each of the first through eighth hinge regions to form the container can comprise folding the shell at each of the first through eighth hinge regions according to a predetermined sequence of folds. In any embodiment, the shell can be folded at the first and second hinge regions before the shell is folded at the third and fourth hinge regions. In any embodiment, the shell can be folded at the first and second hinge regions before the shell is folded at the fifth and sixth hinge regions. In any embodiment, the shell can be folded at the first and second hinge regions before the shell is folded at the seventh and eighth hinge regions. In any embodiment, the shell can be folded at the first and second hinge regions before the shell is folded at the third, fourth, fifth, sixth, seventh and eighth hinge regions.

In any of the above embodiments, the object can be disposed in a tray; wherein the tray has a tray bottom and a plurality of tray sidewalls, the tray bottom and tray sidewalls defining a third 3-dimensional shape; wherein the second 3-dimensional shape can be wholly contained within the third 3-dimensional shape

In any of the above embodiment, the method further can comprise positioning a spacer element between the object to be sterilized or the tray, if present, and at least one panel or flap of the container. In any of the above embodiments, forming the container further can comprise securing a first panel or a first flap, if present, to a second panel or a second flap, if present.

In any of the above embodiments, folding the shell can comprise entrapping a portion of the liner between two or more flaps or panels. In any of the above embodiments, folding the shell at the fourth hinge region can comprise entrapping a portion of the liner between the first flap and the top wall panel. In any of the above embodiments, folding the shell at the sixth hinge region can comprise entrapping a portion of the liner between the second flap, and the top wall panel. In any of the above embodiments, folding the shell at the eighth hinge region can comprise entrapping a portion of the liner between the third flap, and the top wall panel. In any of the above embodiments, the method further can comprise fastening at least one panel to at least one other panel and/or at least one flap.

In any of the above embodiments, the method further can comprise subjecting the container with the object disposed therein to a sterilization process. In any of the above embodiments, the method further can comprise unfolding the container. In some embodiments, unfolding the container can comprise simultaneously unwrapping the liner to expose the object. In some embodiments, the method further can comprise removing the object and liner from the container, removing the object from the liner, reforming the container with the object and not the liner disposed therein, and exposing the reformed container to a washing process.

In another aspect, the present disclosure provides an article. The article can comprise a foldable shell. The foldable shell can have a first folded state that defines a container. The foldable shell can comprise a plurality of panels that includes a bottom panel, three or more sidewall panels and at least one flap. Each of the three or more sidewall panels can be hingedly connected to the bottom panel. The at least one flap can be hingedly connected to one of the three or more sidewall panels. The at least one flap can be configured to overlap one of the three or more sidewall panels in the first folded state. In any of the above embodiments of the article, the foldable shell can have a substantially planar unfolded state. In any of the above embodiments of the article, the foldable shell can have a substantially planar second folded state.

In any of the above embodiments of the article, the three or more wall panes can consist of four wall panels and a top wall panel. In some embodiments, the container can define a rectangular parallelepiped shape. In any of the above embodiments of the article, the bottom panel can have a bottom panel area circumscribed by a bottom panel first edge, a bottom panel second edge, a bottom panel third edge, and a bottom panel fourth edge. The three or more wall panels can comprise a first sidewall panel having a first sidewall panel area circumscribed by a first sidewall panel first edge, a first sidewall panel second edge, a first sidewall panel third edge, and a first sidewall panel fourth edge, wherein the first sidewall panel first edge is foldably connected to the bottom panel first edge at a first hinge region, wherein the first sidewall panel third edge is foldably connected to a top wall panel at a second hinge region; a second sidewall panel having a second sidewall panel area circumscribed by a second sidewall panel first edge, a second sidewall panel second edge, a second sidewall panel third edge, and a second sidewall panel fourth edge, wherein the second sidewall panel first edge is foldably connected to the bottom panel second edge at a third hinge region, wherein the second sidewall panel third edge is foldably connected to a first flap at a fourth hinge region; a third sidewall panel having a third sidewall panel area circumscribed by a third sidewall panel first edge, a third sidewall panel second edge, a third sidewall panel third edge, and a third sidewall panel fourth edge, wherein the third sidewall panel first edge is foldably connected to the bottom panel third edge at a fifth hinge region; and a fourth sidewall panel having a fourth sidewall panel area circumscribed by a fourth sidewall panel first edge, a fourth sidewall panel second edge, a fourth sidewall panel third edge, and a fourth sidewall panel fourth edge, wherein the fourth sidewall panel first edge is foldably connected to the bottom panel fourth edge at a seventh hinge region.

In any embodiment of the article, the shell can comprise a self-supporting material. In any embodiment of the article, the shell can comprise a metal, a plastic material, a ceramic material, a composite material, or a combination of any two or more of the foregoing materials. In any embodiment of the article, at least two of the panels can be foldably connected via a hinge structure. In any embodiment of the article, at least one hinge region is operationally controlled by a stop structure. In any of the above embodiments of the article, at least one panel further can comprise means for permitting fluid flow there through. In any of the above embodiments of the article, at least one panel further can comprise means for permitting fluid flow there through. In any of the above embodiments of the article, the means for permitting fluid flow can comprise at least one opening.

In any of the above embodiments, the article further can comprise a liner that is substantially impermeable to microorganisms wherein, in the unfolded state, the bottom panel and the at least three sidewall panels of the foldable shell collectively define a first area; wherein the liner is shaped and dimensioned to define a second area in which the first area fits; wherein the liner is attached to at least one panel or at least one flap of the foldable shell. In some embodiments, the at least one panel can comprise the bottom panel. In any embodiment, the at least one panel or at least one flap can comprise a plurality of panels and/or flaps. In any embodiment, the liner can be detachably attached to the foldable shell. In some embodiment, the liner can be repositionably attached to the foldable shell.

In another aspect, the present disclosure provides a kit comprising any of the above embodiments of the article. In any embodiment, the kit further can comprise a tray, a liner, or a spacer element.

In another aspect, the present disclosure provides a sterilization packaging system. The sterilization packaging system can comprise an article comprising a foldable shell and a liner that is substantially impermeable to microorganisms. The foldable shell can have a first folded state that defines a container. The foldable shell can comprise a plurality of panels that includes a bottom panel, three or more sidewall panels and at least one flap. The three or more sidewall panels each can be hingedly connected to the bottom panel. The at least one flap can be hingedly connected to one of the sidewall panels. In any embodiment of the sterilization packaging system, in the unfolded state, the bottom panel and the at least three sidewall panels of the foldable shell collectively define a first area; wherein the liner is shaped and dimensioned to define a second area in which the first area fits.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The terms “comprises” and variations thereof do not have a limiting meaning where these terms appear in the description and claims.

As used herein, “a,” “an,” “the,” “at least one,” and “one or more” are used interchangeably. Thus, for example, a liner can be interpreted to mean “one or more” liners.

The term “and/or” means one or all of the listed elements or a combination of any two or more of the listed elements.

Also herein, the recitations of numerical ranges by endpoints include all numbers subsumed within that range (e.g., 1 to 5 includes 1, 1.5, 2, 2.75, 3, 3.80, 4, 5, etc.).

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

Additional details of these and other embodiments are set forth in the accompanying drawings and the description below. Other features, objects and advantages will become apparent from the description and drawings, and from the claims.

### BRIEF DESCRIPTION OF DRAWINGS

The present invention will be further explained with reference to the drawing figures listed below, where like structure is referenced by like numerals throughout the several views.

FIG. 1 is a plan view of an exemplary embodiment of a foldable shell having a plurality of panels and a plurality of flaps in an unfolded state according to the present disclosure.

FIG. 2 is another plan view of the foldable shell of FIG. 1, showing a plurality of edges associated with each panel and flap.

FIG. 3 is another plan view of the foldable shell of FIG. 1, showing the hinge regions that foldably connect each panel to at least one other panel and, in some instances, a flap.

FIG. 4 is a top perspective view of an exemplary embodiment of a foldable shell in an unfolded state according to the present disclosure.

FIG. 5 is a plan view of the foldable shell in an unfolded state with a liner operably positioned thereon.

FIG. 6 is a top perspective view the foldable shell of FIG. 5 with a liner operably positioned thereon.

FIG. 7 is a top perspective view of the foldable shell and liner of FIG. 6 with a tray operably positioned thereon.

FIG. 8 is a top perspective view of the foldable shell, liner, and tray of FIG. 7 with the shell and liner each disposed in a first partially-folded state after folding the shell at the first hinge region.

FIG. 9 is a top perspective view of the foldable shell, liner, and tray of FIG. 8 with the shell and liner each disposed in a second partially-folded state after folding the shell at the second hinge region.

FIG. 10 is a top perspective view of the foldable shell, liner, and tray of FIG. 9 with the liner being placed into position prior to an operation fold of the foldable shell at the seventh hinge region.

FIG. 11 is a top perspective view of the foldable shell, liner, and tray of FIG. 10 with the shell and liner each disposed in a fourth partially-folded state after folding the shell at the seventh hinge region and the eighth hinge region.

FIG. 12 is a top perspective view of one side of the foldable shell, liner, and tray of FIG. 11.

FIG. 13 is a top perspective view of the side of the foldable shell, liner, and tray of FIG. 12 with the liner being placed into position prior to an operational fold of the foldable shell at the third hinge region.

FIG. 14 is a top perspective view of the side of the foldable shell, liner, and tray of FIG. 12 with the liner being placed into an alternative position prior to an operational fold of the foldable shell at the third hinge region.

FIG. 15 is a top perspective view of the side of the foldable shell, liner, and tray of FIG. 12 with the shell and liner each disposed in a fifth partially-folded state after folding the shell at the third hinge region.

FIG. 16 is a top perspective view of the side of the foldable shell, liner, and tray of FIG. 15 with the shell and liner each disposed in a sixth partially-folded state after folding the shell at the fourth hinge region.

FIG. 17 is a top perspective view of the side of the foldable shell, liner, and tray of FIG. 16 with the liner being placed into a position prior to an operational fold of the foldable shell at the fifth hinge region.

FIG. 18 is a top perspective view of another side of the foldable shell, liner, and tray of FIG. 17 with the liner being placed into another position prior to an operational fold of the foldable shell at the fifth hinge region.

FIG. 19 is a rear view of the foldable shell of FIG. 18.

FIG. 20 is a front perspective view of the foldable shell of FIG. 19 with the liner being placed into a position prior to an operation fold of the foldable shell at the sixth hinge region.

FIG. 21 is a top perspective view of the container formed when the foldable shell of FIG. 4 is placed in the first folded state according to the present disclosure.

FIG. 22 is a top perspective view of the foldable shell of FIG. 4 in a second folded state according to the present disclosure.

FIG. 23 is a top perspective view of the foldable shell of FIG. 22 as it is being moved into a third folded state according to the present disclosure.

FIG. 24 is a perspective view of another embodiment of a foldable shell, the foldable shell having a plurality of flaps and panels each flap and panel comprising a plurality of openings to permit fluid flow there through, according to the present disclosure.

FIG. 25a is a perspective view of one embodiment of a partially-folded foldable shell with a tray disposed therein, the tray having a smaller height than the foldable shell in its folded state.

FIG. 25b is a perspective view of the partially-folded foldable shell of FIG. 25a with one embodiment of a spacer element disposed on top of the tray that is disposed in the foldable shell.

FIG. 26a is a perspective view of one embodiment of a partially-folded foldable shell with a tray disposed therein, the tray having a smaller width than the foldable shell in its folded state.

FIG. 26b is a perspective view of the partially-folded foldable shell of FIG. 25a with another embodiment of a spacer element disposed alongside the tray that is disposed in the foldable shell.

FIG. 27a is a perspective view of the spacer element of FIG. 25b.

FIG. 27b is a perspective view of the spacer element of FIG. 26b.

FIG. 28 is a perspective view of one embodiment of an alternative embodiment of a spacer element according to the present disclosure.

### DETAILED DESCRIPTION

The present disclosure generally relates to compositions and methods for preparing an object to be sterilized. The article comprises a foldable shell, optionally, with a liner attached thereto. The article and liner can be used in a method to form a container around an object to be sterilized. While forming the container, the object is simultaneously wrapped with the liner and the liner is secured around the object without having to use additional secural means to secure the liner around the object.

Articles of the present disclosure comprise a foldable shell. The foldable shell has a substantially planar unfolded state and a first folded state that defines a container. The container can be used to hold an object or a plurality of objects therein during and, optionally, after the container is subjected to a sterilization process.

The object to be sterilized can be any object that is appropriate to subject to a sterilization process. Non-limiting examples of suitable objects include surgical tools, medical devices, dental instruments, dressings, and bandages. In any embodiment, the object may be disposed in a wrapping material suitable for holding an object to be sterilized. The exterior surface of the object, including any optional wrapper, defines a first volume having a first size and a first shape.

The panels that form the container of the present disclosure define a second volume having a second size and a second shape into which the first volume fits. Thus, when the container is subjected to a sterilization process, any object disposed therein is also subjected to the sterilization process. The sterilization process may include the use of one or more of a variety of sterilants (e.g., gaseous sterilants such as moist steam, ethylene oxide, gas plasma, and the like).

In a preferred embodiment, the object to be sterilized is disposed in a tray. The tray can comprise a tray bottom and a plurality of tray sidewalls, the interior surface of the tray bottom and tray sidewalls define a third volume having a third size and a third shape into which the first volume fits. Optionally, the tray further comprises a lid, which further defines the third volume. Moreover, when the tray is used with the container of the present disclosure, the third volume fits into the second volume. Thus, when the container is subjected to a sterilization process, a tray disposed therein and any object disposed in the tray are also subjected to the sterilization process. The sterilization process may include the use of one or more of a variety of sterilants (e.g., gaseous sterilants such as moist steam, ethylene oxide, gas plasma, and the like).

Thus, a container that is intended for use in steam sterilization may be formed from a foldable shell that is made of any one or more material that is compatible with steam sterilization and can maintain its integrity during and after exposure to the steam sterilization process. Accordingly, materials such as, for example, metals, plastics, composites and hybrids thereof are suitable to fabricate containers to be used in a steam sterilization process. In any embodiment, the foldable shell can be formed from a material (e.g., a sheet material) that is self-supporting. Furthermore, a container that is intended for use in gas (e.g., ethylene oxide, ozone) sterilization may be formed from a foldable shell that is made of any one or more material that is compatible with the gas and can maintain its integrity during and after exposure to the gaseous sterilant. In addition, a container that is intended for use with gas plasma sterilization may be formed from a foldable shell that is made of any one or more material that is compatible with gas plasma sterilization such as, for example, metal, anodized metal, conductive plastics, composites thereof and hybrids thereof. Where gas plasma sterilization is used, the foldable shell may be constructed of another material that is not detrimental to the system as a whole.

Suitable materials for the construction of the foldable shell include, without limitation, metals such as stainless steel, aluminum, titanium, and magnesium, as well as alloys of any of these, plastics (which in the case of gas plasma suitable products are conductive plastics), metal filled plastics, carbon filled plastics, carbon/plastic composites and hybrids, metal/plastic composites and hybrids, and the like. Each of the metals or metal alloys may or may not have an anodic coating thereon, but preferably do have the anodic coating, especially if the metal is sensitive to the sterilant. A highly preferred metal is aluminum or aluminum alloy, especially aluminum alloy 0019, any of the series 2000 alloys, any of the series 5000 alloys, or any of the series 6000 alloys. A particularly suitable one of the series 5000 is 5052 and a particularly suitable one of the series 6000 is 6061. The anodic coating, when present in devices that are used in sterilization modes other than gas plasma sterilization, may be of any desired thickness. For devices that will be used in gas plasma sterilization, the anodic thickness is preferably maintained at not greater than about 0.5 mils (12.7 micrometers), more preferably not greater than about 0.4 mils (10.2 micrometers), more preferably not greater than about 0.35 mils (8.9 micrometers), and while any such thickness below the maximums indicated here are suitable, in highly preferred embodiments, the anodic thickness is at least about 0.05 mils (1.3 micrometers), more preferably at least about 0.1 mils (2.5 micrometers), even more preferably at least about 0.15 mils (3.8 micrometers), still more preferably at least about 0.2 mils (5.1 micrometers), and most preferably at least about 0.25 mils (6.4 micrometers). When the metal used in any of the above components is aluminum or an aluminum alloy, the metal or alloy may be optionally heat treated, if desired, preferably to T4, T5, or T6. T4 or T5 are more preferred because they are easier to attain in practice. However, heat treatment of the metal is not required.

When plastics are used to fabricate the foldable shell, the plastic can be any autoclavable plastic, with polypropylene, polysulfone, poly(etherimide), and liquid crystal polymer (LCP) being preferred. When a conductive component is necessary, but the foregoing materials are not themselves conductive (e.g., polypropylene), a composite or hybrid material such as a metal or carbon-filled plastic or a metal or carbon composite with the non-conductive material can be used. Metal or carbon materials that are completely or nearly completely contained within the plastic (i.e. will not be significantly exposed directly to the sterilant) are suitable and can be chosen from any metal or carbon source that will provide the requisite electrical conductivity, without concern for sensitivity to the sterilant. Where the metal or other material is used in a fashion that it will be exposed to the sterilant, it is preferable to utilize such materials that are resistant to corrosion by the sterilant or to apply protective layers such as anodic coatings on metals. As an alternative to this, a conductive surface may be applied in any suitable manner to a non-conductive surface. As such, an aluminum layer may be applied to a non-conductive shell material in any convenient manner such as, for example, by wrapping the surfaces with metal foil or by vapor deposition and other techniques known in the art. Once the conductive layer has been applied and any perforation made, if desirable, any anodic layer that is deemed needed should then be applied so that the entire exposed conductive surface can be layered with an anodic coating. While applying the anodic coating before perforation is possible, doing so may allow for small segments of the conductive surface to be exposed to sterilant during use.

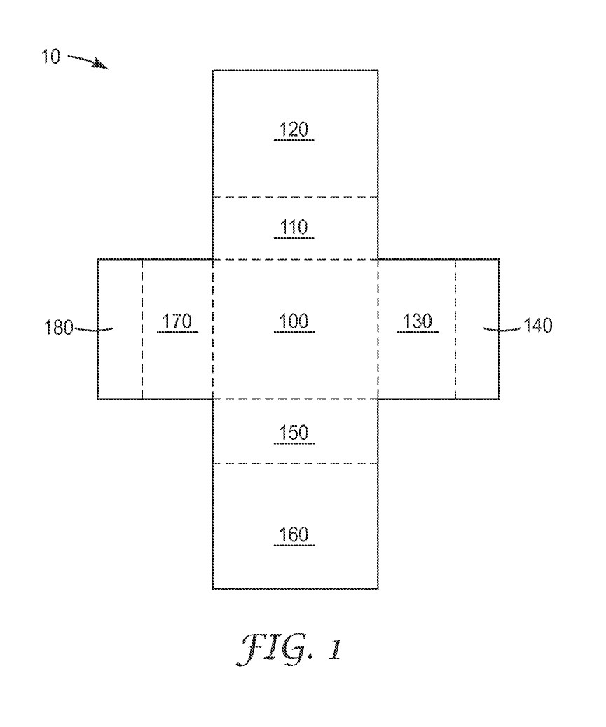

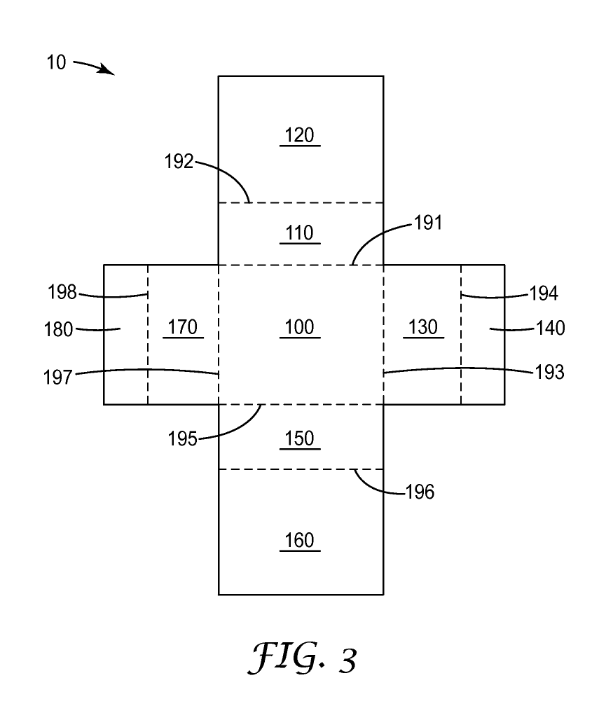

In one aspect the present disclosure provides an article comprising a foldable shell. The foldable shell has a first folded state that defines a container. In the first folded state, the container can define one of a variety of three-dimensional shapes. In an embodiment, the shape defined by the first folded state of the container is a rectangular parallelepiped shape. In another embodiment, the first folded state of the container defines a substantially cuboidal shape. The foldable shell comprises a plurality of panels that includes a bottom panel, three or more wall panels, and at least one flap. Each of the three or more wall panels is hingedly connected to the bottom panel and the flap is hingedly connected to one of the plurality of panels (e.g., one of the sidewall panels). FIGS. 1-3 show plan views of one embodiment of an article comprising a foldable shell 10 according to the present disclosure. The foldable shell 10 comprises a plurality of panels (shown in FIG. 1), each panel foldably connected to at least one other panel. “Foldably connected”, as used herein, refers to two panels (or a panel and a flap) that are coupled to each other at a hinge region (shown in FIG. 3). The hinge region may comprise any suitable hinge material and/or mechanism that permit the panels to be folded into the first folded state and to maintain the first folded state during and after the sterilization process. In a preferred embodiment, the hinges in the hinge region are mounted into an embossed surface of the shell to obviate the potential for tearing of a liner that is to be used with the foldable shell.

Each hinge region constitutes a fold locus (i.e., a location at which the foldable shell is folded in the process of forming the container. In any embodiment, the hinge region may comprise a friction hinge (e.g., a torque hinge or a constant-torque friction hinge) in order to hold the foldably connected structural components (e.g., panels and flaps) in a pseudostable orientation relative to each other. An easily constructed friction hinge can be prepared by modifying a piano hinge. The piano hinge can be modified, for example, by replacing one or more of the knuckles of the piano hinge with slotted spring pins having the same length as the knuckles.

In any embodiment, the hinge material may comprise an adhesive film (e.g., tape) which, optionally, may be replaceable if it becomes damaged or loose during use. In any embodiment, the hinge material may extend along a portion of the edges of two foldably-connected panels that are foldably connected via the hinge material. In some embodiments, the hinge material may extend substantially along the full length of the edges of two foldably-connected panels that are foldably connected via the hinge material. In some embodiments, the hinge comprises the same material as the foldable shell and, in these embodiments, the location of a hinge may be defined by a crease, a scored line, or a perforation, for example, that forms a location where the shell material is relatively weaker and, thus, more likely to bend.

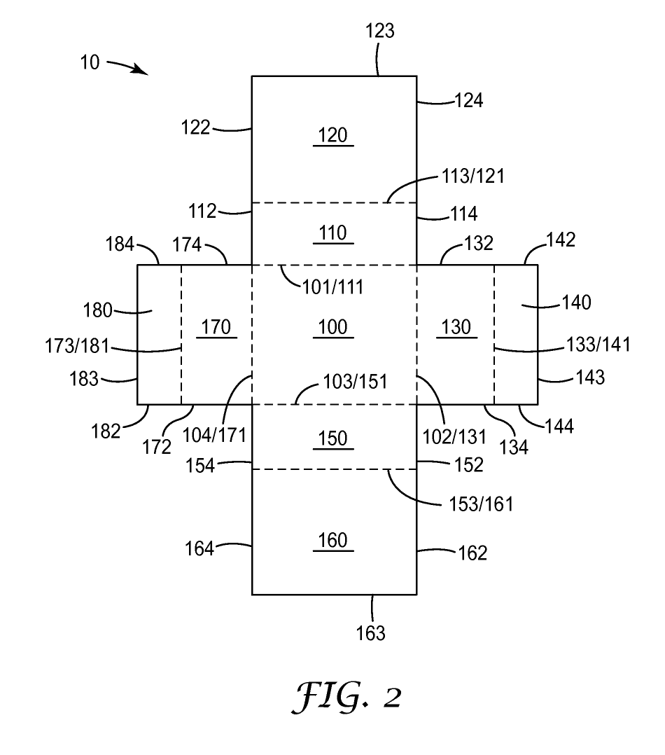

The shell 10 includes a bottom panel 100. In the first folded state of the shell 10, the bottom panel forms the bottom of the container (not shown). FIG. 2 shows the respective edges that delineate each panel of the shell 10. The bottom panel 100 is circumscribed by four edges that are oriented around the bottom panel 100 in the following clockwise order: a bottom panel first edge 101, a bottom panel second edge 102, a bottom panel third edge 103, and a bottom panel fourth edge 104.

Along the bottom panel first edge 101, the bottom panel 100 is foldably connected to a first sidewall panel 110. The first sidewall panel 110 is circumscribed by four edges that are oriented around the first sidewall panel 110 in the following clockwise order: a first sidewall panel first edge 111, a first sidewall panel second edge 112, a first sidewall panel third edge 113, and a first sidewall panel fourth edge 114. Thus, the bottom panel first edge 101 and the first sidewall panel first edge 111 are foldably connected at a first hinge region 191.

Along the first sidewall panel third edge 113, the first sidewall panel 110 is foldably connected to a top wall panel 120. The top wall panel 120 is circumscribed by four edges that are oriented around the top wall panel 120 in the following clockwise order: a top wall panel first edge 121, a top wall panel second edge 122, a top wall panel third edge 123, and a top wall panel fourth edge 124. Thus, the first sidewall panel third edge 113 and the top wall panel first edge 121 are foldably connected at a second hinge region 192.

Along the bottom panel second edge 102, the bottom panel 100 is foldably connected to a second sidewall panel 130. The second sidewall panel 130 is circumscribed by four edges that are oriented around the second sidewall panel 130 in the following clockwise order: a second sidewall panel first edge 131, a second sidewall panel second edge 132, a second sidewall panel third edge 133, and a second sidewall panel fourth edge 134. Thus, the bottom panel second edge 102 and the second sidewall panel first edge 131 are foldably connected at a third hinge region 193. Along the second sidewall panel third edge 133, the third sidewall panel 130 is foldably connected to optional first flap 140 at a fourth hinge region 194.

Along the bottom panel third edge 103, the bottom panel 100 is foldably connected to a third sidewall panel 150. The third sidewall panel 150 is circumscribed by four edges that are oriented around the third sidewall panel 150 in the following clockwise order: a third sidewall panel first edge 151, a third sidewall panel second edge 152, a third sidewall panel third edge 153, and a third sidewall panel fourth edge 154. Thus, the bottom panel third edge 103 and the third sidewall panel first edge 151 are foldably connected at a fifth hinge region 195. Along the third sidewall panel third edge 153, the third sidewall panel 150 is foldably connected to optional second flap 160 at a sixth hinge region 196. In any embodiment, the foldable shell 10 may comprise a first flap 140, second flap 160, or both a first flap 140 and second flap 160, as depicted in the illustrated embodiment.

Along the bottom panel fourth edge 104, the bottom panel 100 is foldably connected to a fourth sidewall panel 170. The fourth sidewall panel 170 is circumscribed by four edges that are oriented around the fourth sidewall panel 170 in the following clockwise order: a fourth sidewall panel first edge 171, a fourth sidewall panel second edge 172, a fourth sidewall panel third edge 173, and a fourth sidewall panel fourth edge 174. Thus, the bottom panel fourth edge 104 and the fourth sidewall panel first edge 171 are foldably connected at a seventh hinge region 197. Along the fourth sidewall panel third edge 173, the fourth sidewall panel 170 is foldably connected to a third flap 180 at an eighth hinge region 198. In any embodiment, the foldable shell 10 may comprise a first flap 140, second flap 160, third flap 180 or a combination of any two or more of the foregoing flaps. Thus, in any embodiment, the foldable shell 10 comprises at least one flap that is hingedly connected to one of plurality of panels (e.g., one of the sidewall panels).

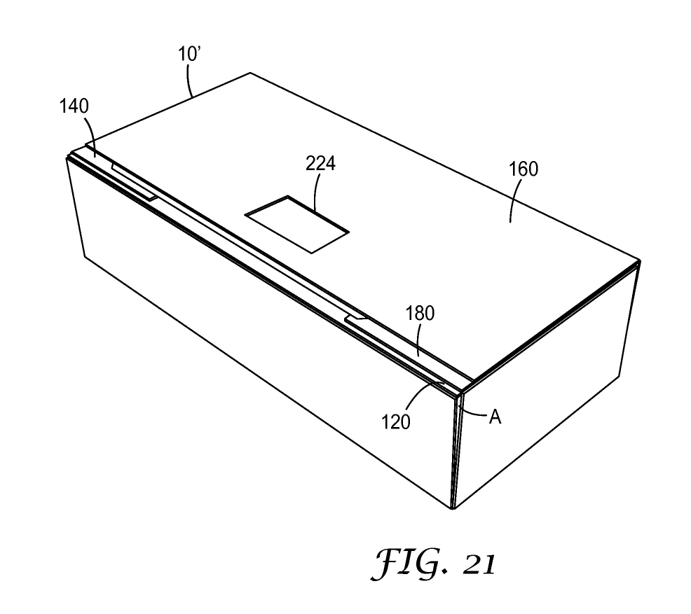

It can be seen in FIGS. 1-5 and FIG. 21 that the second flap 160 has approximately the same dimensions (i.e., length and width) as the top wall panel 120 and that the first flap 140 and third flap 180 have smaller dimensions than the second flap 160. However, this is not a requirement of the foldable shell of the present disclosure. It is contemplated that all of the first through third flaps may have the same dimensions and that the dimensions of each of the first through third flaps (i.e., 140, 160, and 180, respectively) may be equal to or smaller than the dimensions of the top wall panel 120. In a preferred embodiment, at least one of the first through third flaps has approximately the same dimensions as the top wall panel and the at least one flap is the last flap that is folded to complete the formation of the container of the present disclosure, as shown in the illustrated embodiment of FIG. 21.

In addition, it can be seen in FIG. 2 that the edge of each of the first through third flaps of the illustrated embodiment extends the entire length of the edge of the respective panel to which it is foldably attached. While this configuration is preferred to minimize the possibility of excess liner protruding from the assembled container of the present disclosure, it is not a requirement. In some embodiments, the length of at least one flap edge that is foldably attached to a panel is less than the length of the panel edge to which it is foldably attached.

In a preferred embodiment, a foldable shell of the present disclosure is used to form an enclosure around a tray that holds an object to be sterilized. A suitable tray has a shape and dimensions that will permit the tray to fit inside a volume defined by the shape and size of the container formed by the foldable shell in its first folded state. The tray can be fabricated from any material that is compatible with the sterilization process to which the tray will be subjected. Suitable materials include the materials from which the shell can be fabricated, as disclosed herein.

A foldable shell of the present disclosure is used with a liner to prepare an object, optionally in a tray, for sterilization. When used in a method according to the present disclosure, the liner and shell form concentric protective layers around the object, wherein the liner forms an inner protective layer proximate the object and the foldable shell forms an outer container surrounding the liner. The inner layer provides a barrier to prevent direct access from a location outside the container to the object inside the container. “Direct access”, as used herein, means that there exists an uninterrupted (e.g., uninterrupted by the container and/or the liner) straight-line path from a microorganism located outside the container to any portion of the object inside the container. Accordingly, when used in a method according to the present disclosure, the assembly of the liner in the container creates a structure in which a microorganism must follow a nonlinear path, preferably a tortuous path, to get to the object from a location outside the container.

The liner can be any material known in the art to be suitable for wrapping objects to be sterilized. The liner also advantageously serves as a microbial filter so that after it is sterilized, the liner-wrapped object can remain sterile until use. The liner material is thus selected from the group consisting of disposable or reusable materials such as medical grade cellulosic materials (for example paper, etc.); polypropylene or other non-woven polyolefins; linen or muslin, etc; or synthetic wrap (for example GORTEX, Teflon, polyfoil compounds, TYVEK film); or mixtures or blends. In addition, the liner may be a composite of multiple layers where each layer provides some, but not all, of the desired characteristics. Preferably, the liner material is configured in substantially flat sheets. Advantageously, flat sheets allow for the use of one size sheet for multiple sizes of objects to be wrapped. Furthermore, as the container provides an outer protective surface for the contents, the liner itself may be a single wrap as opposed to double wrapping or sequential layering of multiple wrap layers.

The liner may optionally be a material that is not typically used for wrapping objects to be sterilized. For example, the liner may be an impermeable film. Such a liner of impermeable film may be used when the foldable shell and liner contain a path (e.g., a hole) that allows sterilant to enter the container and pass through the liner through a filter that may be positioned on the exterior or interior surface of the shell or on the exterior surface of the impermeable liner.

The liner may be folded around the inner tray to enclose it (and the objects to be sterilized) as the foldable shell is folded into the first folded state, as described and shown herein. The method of the present disclosure permits the operator to wrap the object to be sterilized with the liner without having to separately wrap the object and secure the wrapping material around the object with tape or other fastening means prior to putting the object to be sterilized into an outer container. This provides an improvement over the method described in U.S. Patent Application Publication No. 2007/0095699; incorporated herein by reference in its entirety; which involves separately wrapping the object to be sterilized before completing the formation of an outer container that surrounds the object. Moreover, the method of the present invention does not require that the liner is fastened (e.g., using VELCRO closures or adhesive tape) before folding any of the panels or flaps of the foldable shell to complete the assembly of the container of the present disclosure. Advantageously, the method of use of the present disclosure permits the operator to unwrap the sterilized object from the liner simultaneously while unfolding the foldable shell. Because the object to be sterilized is enfolded by a lamellar structure comprising the liner and foldable shell, the process of unfolding the foldable shell can simultaneously accomplish a plurality of desirable outcomes including 1) releasing the object from the container in which it was sterilized, 2) opening the liner engulfing the object, and 3) preserving the sterile field around the object. Accordingly, the customary additional steps of untaping and unwrapping the sterilized object, both of which involve a risk of compromising the sterility of the object and/or the sterile field around it, are eliminated by the method of the present disclosure.

The present disclosure provides a method of preparing an object for sterilization. The method includes providing an object to be sterilized that, optionally, is disposed in a tray. The method further comprises providing a foldable shell and a liner. The foldable shell comprises a plurality of panels that includes a bottom panel and three or more sidewall panels, the three or more sidewall panels each being hingedly connected to the bottom panel. Optionally, the foldable shell further may comprise one or more flaps, as disclosed herein. The foldable shell has an unfolded state and a first folded state that defines a container.

In any embodiment of the method, the foldable shell can be provided with the liner attached (e.g., by using an adhesive, a mechanical attachment means, or by using shell materials and liner materials that have complementary interlocking surface features such as hook-and-loop features, for example, that provide capability for mechanical attachment) to at least one panel or to at least one flap of the foldable shell, if present. It is also contemplated that the foldable shell can be provided with the liner attached to a plurality of panels and/or flaps. For example, the liner may be attached to the bottom panel, the top wall panel, the first sidewall panel, the second sidewall panel, the third sidewall panel, the fourth sidewall panel, the first flap panel, the second flap, the third flap, or the liner may be attached to any two or more of the foregoing portions of the foldable shell. In any embodiment, the liner may be detachably attached to the foldable shell. In some embodiments, the detachable liner may be repositionably attached to the shell (e.g., via a repositional adhesive). An example of a repositional liner is described in PCT International Patent No. WO 2012/092116; which is incorporated herein by reference in its entirety. Advantageously, providing a foldable shell with a repositionably attached liner can permit the operator to detach the liner, reposition it in any desirable location relative to the foldable shell and the object to be sterilized, and, optionally, reattach the liner to the foldable shell to secure it in the proper position for the folding process.

In any embodiment, the liner may be detachably attached to the foldable shell via mechanical attachment structures (e.g., a clamp, an alligator clip, hook-and-loop attachment means, and the like; not shown). In a preferred embodiment, the mechanical attachment structure can be coupled (e.g., via an adhesive, a rivet, a screw, or the like) to the bottom panel, the top panel, the first sidewall panel, the second sidewall panel, the third sidewall panel, the fourth sidewall panel, or to any of the flaps, if present, or the liner may be attached to any two or more of the foregoing panels or flaps of the foldable shell (not shown). In addition to positioning the liner in a proper location to envelope the object with the liner while folding the foldable container, the attachment structure further can facilitate the process of unwrapping the object with minimal handling of the liner during the unwrapping process (i.e., unfolding the container simultaneously unwraps the object enclosed by the liner because the liner is attached to the container while the container is being unfolded).

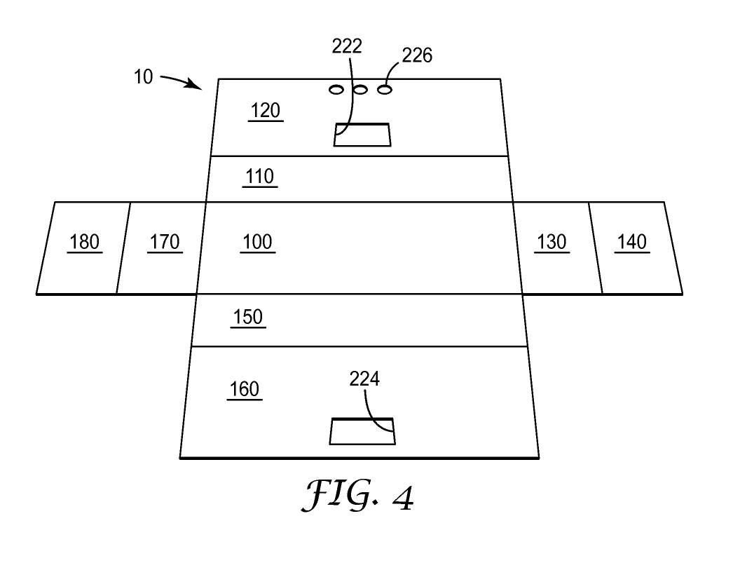

The foldable shell is placed on a surface, preferably a substantially flat, level surface (e.g., a table), before use. FIG. 4 shows a top perspective view of one embodiment of a foldable shell 10 according to the present disclosure. The foldable shell 10 is disposed on a flat surface with the shell 10 in the unfolded state. The foldable shell 10 comprises a bottom panel 100 foldably connected to four sidewall panels (110, 130, 150, and 170, respectively). The first sidewall panel 110 is foldably connected to the top wall panel 120. The top wall panel 120 includes optional grip holes 226 for handling the foldable shell and an optional first window 222. In some embodiments, the first window 222 may include a covering (not shown) to prevent the passage of microorganisms through the first window 222. The first window 222 functions to permit efficient passage of a sterilant gas or steam through the shell 10 when the shell is made of material that otherwise resists the passage of the sterilant steam or gas there through. Thus, the covering may be fabricated from any suitable microbial barrier material (e.g., filter paper, liner material, and/or the self-sealing filter disclosed in U.S. Patent Application No. 61/490,344, which is incorporated herein by reference in its entirety) that is compatible with the sterilization process and that permits more efficient passage of the sterilant than the material from which the shell is made. The covering may be attached (e.g., adhesively attached) to the shell 10 and, optionally, may be replaceable after use. The second sidewall panel 130 is foldably attached to the first flap 140. The third sidewall panel 150 is foldably attached to the second flap 160. The second flap 160 further comprises a second window 224 that, optionally, may include a covering (not shown) with the same properties as the covering described for the first window 222. The second window 224 is dimensioned and positioned such that, when the shell 10 is in the first folded state, the second window 224 substantially superimposes the first window 222, thereby permitting efficient passage of the sterilant gas or steam into the container formed by the shell 10. The fourth sidewall panel 170 is foldably connected to the third flap 180.

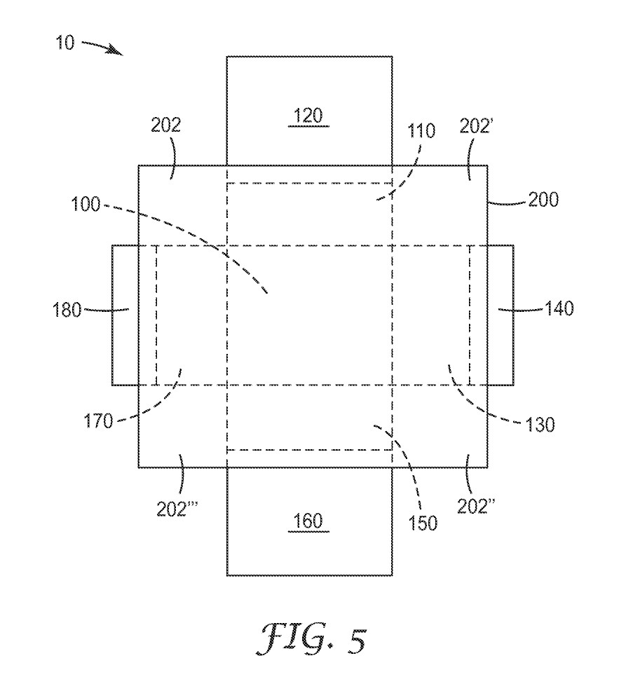

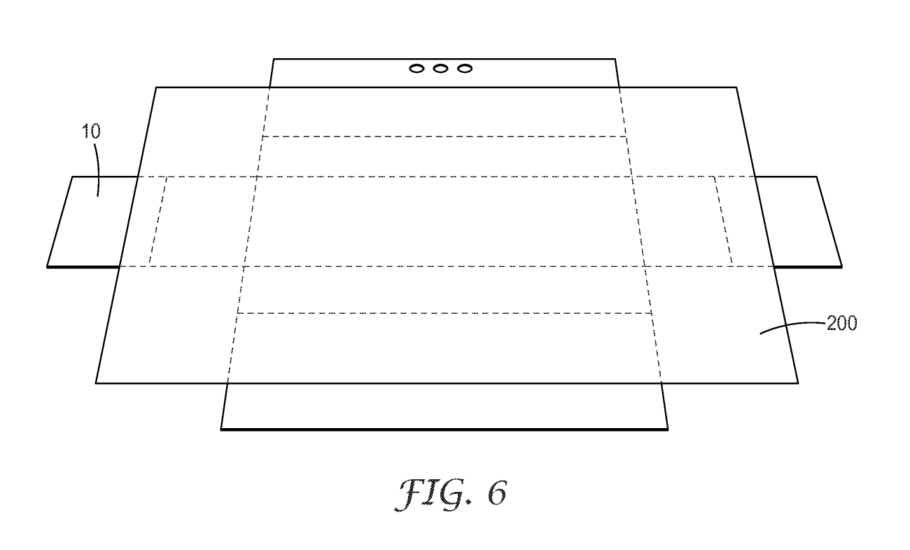

After the foldable shell is placed on a surface, a liner, if not provided attached to the shell in an operational starting position, is positioned on the foldable shell in an operational starting position. FIG. 5 shows a plan view and FIG. 6 shows a top perspective view of a foldable shell 10 with a liner 200 placed thereon in an operational starting position. In an operational starting position, the liner 200 superimposes (e.g., completely superimposes) the bottom panel 100 and all four sidewall panels (110, 130, 150, and 170, respectively). Preferably, in the operational starting position, the liner 200 superimposes a portion of each of the top wall panel 120, the first flap 140, the second flap 160, and the third flap 180. Excess portions of the liner (portions 202, 202′, 202″, and 202′″, respectively) that extend outside the area defined by the shell 10 are tucked into the container that is formed by the shell 10, as described hereinbelow.

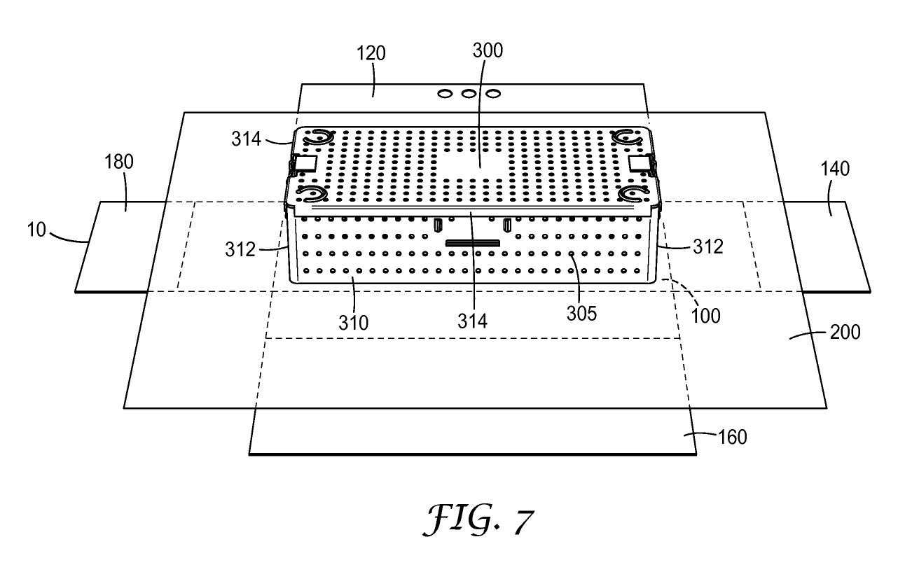

After the liner 200 is operationally positioned on the foldable shell 10, the object to be sterilized is positioned on the liner 200 as shown in FIG. 7. Preferably, the object to be sterilized is placed on the liner in a position that superimposes (e.g., substantially superimposes) the bottom panel 100 of the shell 10. In the illustrated embodiment, the object to be sterilized is provided in a sterilizable tray 300 having a rectangular parallelepiped shape. The tray 300 comprises optional perforations 305 to facilitate the passage of sterilant to the interior of the tray 300. The tray further has a plurality of edges (e.g., top edges 314, side edges 312, and bottom edges 310 over which the liner 200 is positioned as the shell 10 is folded into its first folded state, as described herein. Also shown in FIG. 7 are the top wall panel 120, the first flap 140, the second flap 160, and the third flap 180.

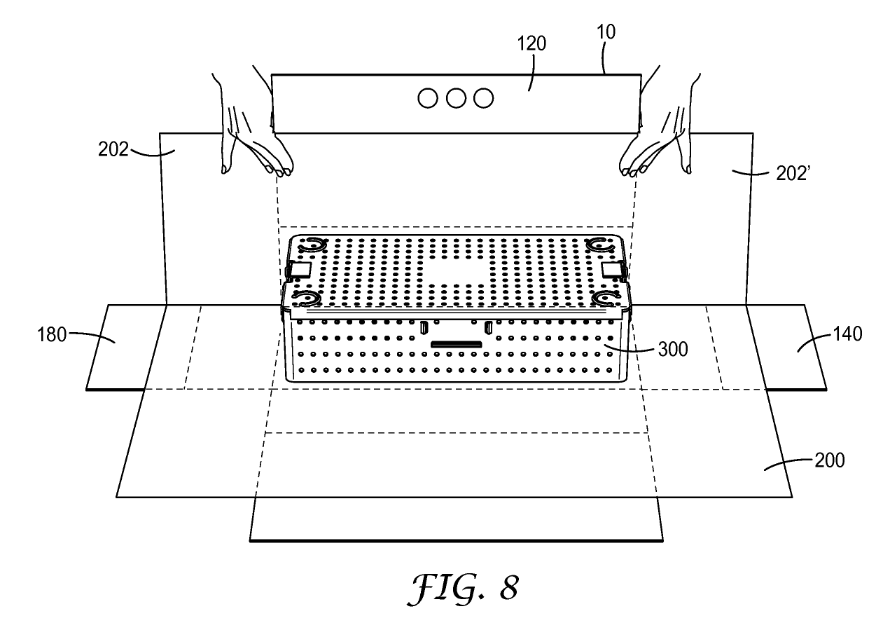

After positioning the tray 300 on the liner 200, the foldable shell 10 is folded at the first hinge region. “Folding the shell at a hinge region”, as used herein, means folding the shell at the hinge region until the panel or flap being moved at the hinge region is moved substantially into its first operational position. Moving a panel or a flap into a “first operational position”, as used herein, refers to moving the panel or flap into the position in which the panel or flap will be disposed when the foldable shell 10 is in the first folded state. Accordingly, folding the shell 10 at the first hinge region moves the first sidewall panel from a substantially horizontal position to a substantially vertical operational position, as shown in FIG. 8. In this first operational position, the first sidewall panel (not shown) is adjacent one of the sidewalls (i.e., the back sidewall, not shown) of the tray 300. Also shown in FIG. 8 are the top wall panel 120, first flap 140, third flap 180, and excess portions (202 and 202′, respectively) of the liner 200.

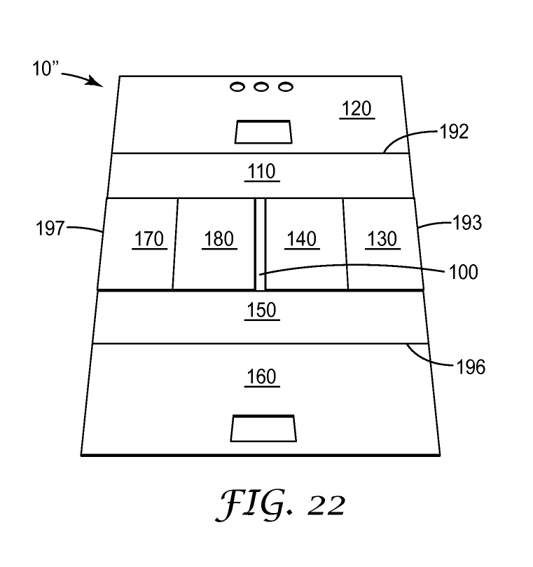

It is contemplated that any hinge region of the present disclosure may hingedly pivot up to at least about 90 degrees, thereby permitting two components (i.e., two adjacent panels or a panel and an adjacent flap) that are hingedly connected so they can be moved from a substantially coplanar configuration to a substantially perpendicular configuration and/or moved from a substantially perpendicular configuration to a substantially coplanar configuration. In some embodiments, at least one hinge region may pivot up to about 180 degrees, thereby permitting the two components that are foldably connected to be hingedly moved from a substantially coplanar configuration to a substantially overlapping configuration (shown in FIG. 22) and/or to be hingedly moved from a substantially overlapping configuration to a substantially coplanar configuration. In some embodiments, at least one hinge region may pivot up to almost 360 degrees. It is further contemplated that one or more hinge regions of the foldable shell of the present disclosure may be configured to pivot up to about 90 degrees, at least one other hinge region may be configured to pivot up to about 180 degrees and, optionally, at least one other hinge region may be configured to pivot up to almost 360 degrees.

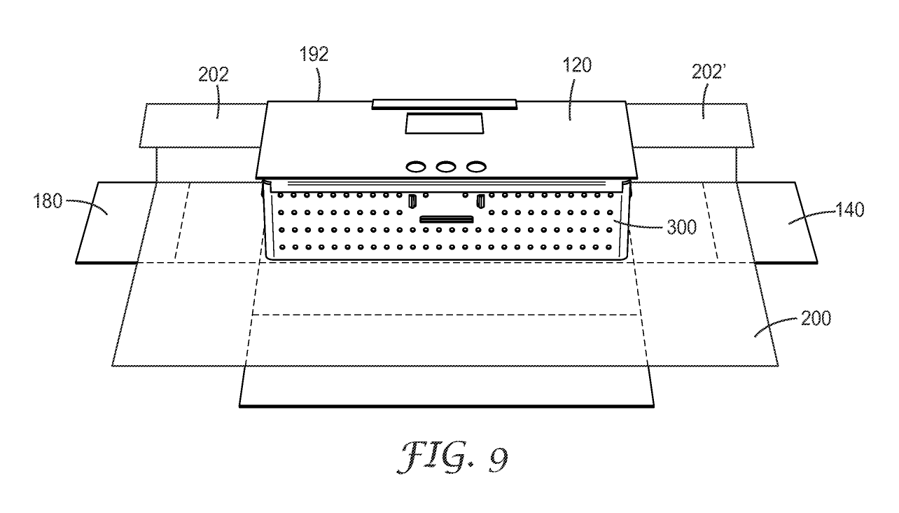

After folding the shell 10 at the first hinge region 191, the shell is folded at the second hinge region 192, thereby moving the top wall panel 120 into an operational position, as shown in FIG. 9. In its first operational position, the top wall panel 120 is positioned adjacent the top surface (or lid) of the tray 300. Also shown in FIG. 9 are the first flap 140, third flap 180, and excess portions (202 and 202′, respectively) of the liner 200. It is noted that folding the shell at the second hinge region bends the liner 200 over one of the top edges (e.g., the rear top edge, not shown) of the tray 300.

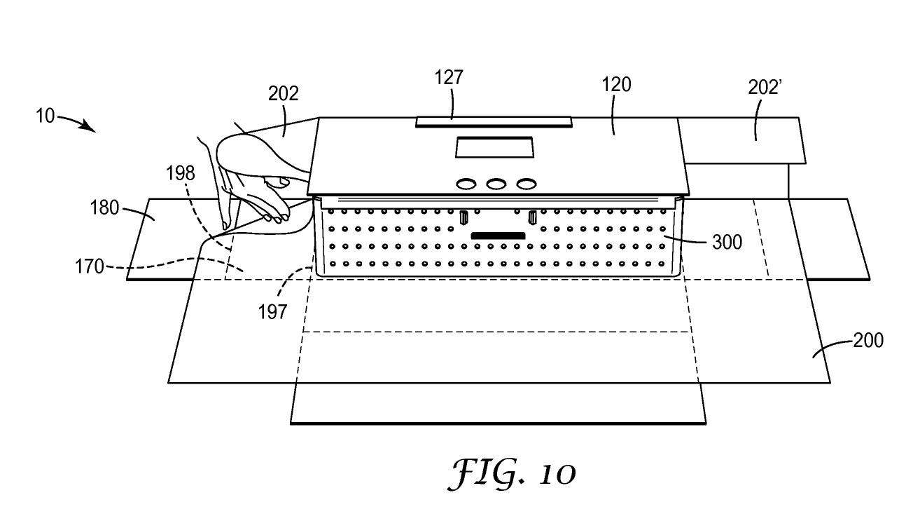

After the top wall panel 120 is in the first operational position shown in FIG. 9, any other sidewall panel can be moved into a first operational position by folding the foldable shell at another hinge region that joins a sidewall panel to the bottom panel. Preferably, the next sidewall panel moved into a first operational position is a sidewall panel proximate the first sidewall panel. In the illustrated embodiment, the next sidewall panel to be moved into an operable position is the fourth sidewall panel, which is foldably attached to the bottom panel at the seventh hinge region. In preparation for folding the shell 10 at the seventh hinge region 197, the excess portion 202 of the liner 200 optionally is tucked into a position adjacent a sidewall of the tray 300, as shown in FIG. 10. Advantageously, this process facilitates two preferable results: 1) the liner is bent around a side edge of the tray 300 (i.e., the left rear side edge of the tray shown in FIGS. 10) and 2) the excess portion 202 is positioned so that, when the shell is folded at the seventh hinge region 197, at least a part of the excess portion 202 is trapped between the fourth sidewall panel 170 and a sidewall (i.e., the left sidewall, as shown in FIG. 10) of the tray 300. Also shown in FIG. 10 are the eighth hinge region 198, the third flap 180, the excess portion 202′ of the liner 200, and a stop structure 127. The stop structure 127 is a structure against which any of the flaps can abut, thereby preventing further movement of the hinge structure that joins the bottom panel to the sidewall to which the flap is foldably attached. For example, when the shell is folded at eighth hinge region 198 to place the third flap 180 into a first operational position, the third flap 180 can abut stop structure 127 (as shown in FIG. 11), thereby preventing further folding at seventh hinge region 197. In addition, door hinge checks are known in the art (see, for example, U.S. Pat. No. 2,586,757, which is incorporated herein by reference in its entirety). A skilled person, in view of the present disclosure, will recognize that a structure such as a door hinge check, for example, can be used in a foldable shell of the present disclosure to bias the movement of two panels relative to each other and/or to bias the movement of a flap and a panel relative to each other. This bias may be used to properly position a flap and/or a panel while folding the foldable shell to form the container.

FIG. 11 shows a top perspective view of the foldable shell 10, liner 200, and tray 300 of FIG. 10 after the shell 10 is folded at the seventh hinge region 197 and eighth hinge region 198. In this position, the fourth sidewall panel 170 is in a first operational position adjacent a sidewall (i.e., the left sidewall) of the tray 300. Furthermore, the third flap 180 is positioned over a portion of the top wall panel 120. That is, at least a portion of top wall panel 120 is disposed between the third flap and the object to be sterilized (i.e., tray 300). The movement of the fourth sidewall panel 170 and the third flap 180 into their respective first operational positions causes the liner to bend over one of the bottom edges (i.e., the left bottom edge) and one of the top edges (i.e., the left top edge) of the tray 300. In addition, placement of the third flap 180 into the first operational position entraps a part 202A of the excess portion of the liner between the third flap 180 and the top wall panel 120. Advantageously, this helps secure the liner 200 in the foldable shell 10 without the need for any additional secural means (e.g., adhesive tape) to secure the liner 200. Also shown in FIG. 11 are excess portions (202′ and 202′″, respectively) of the liner 200, the stop structure 127, and the locations of the third sidewall panel 150 and second flap 160.

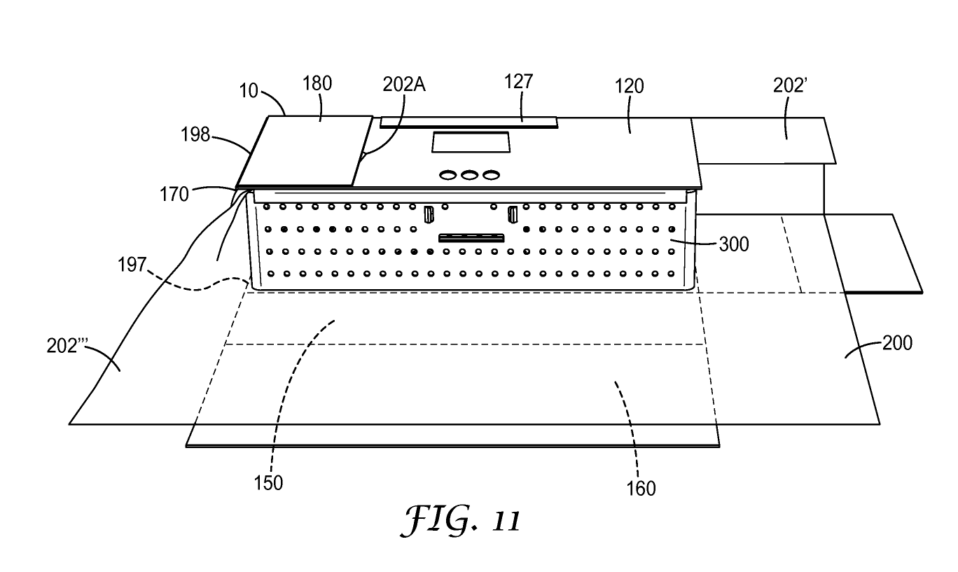

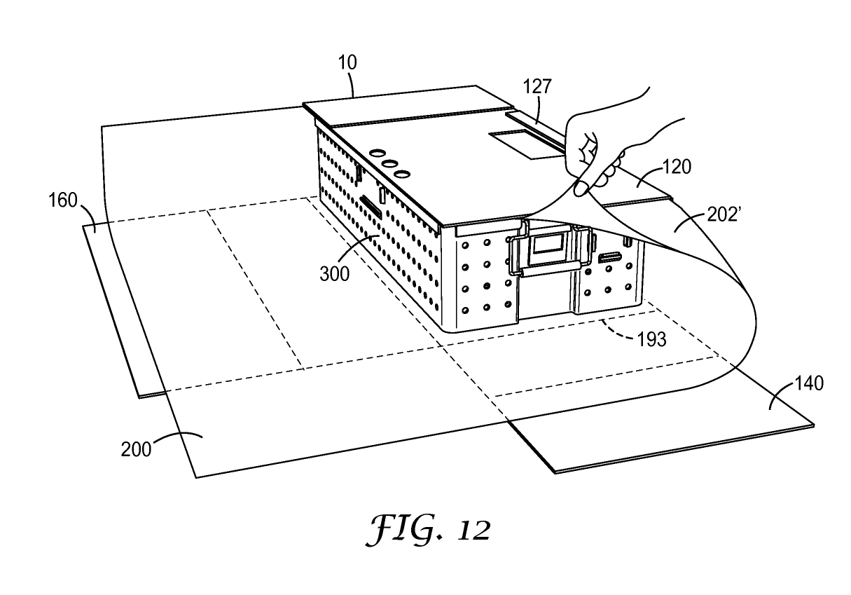

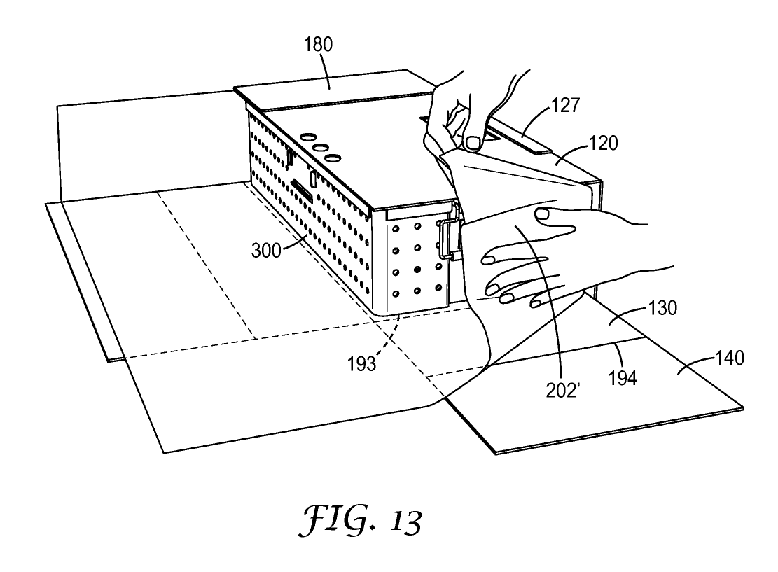

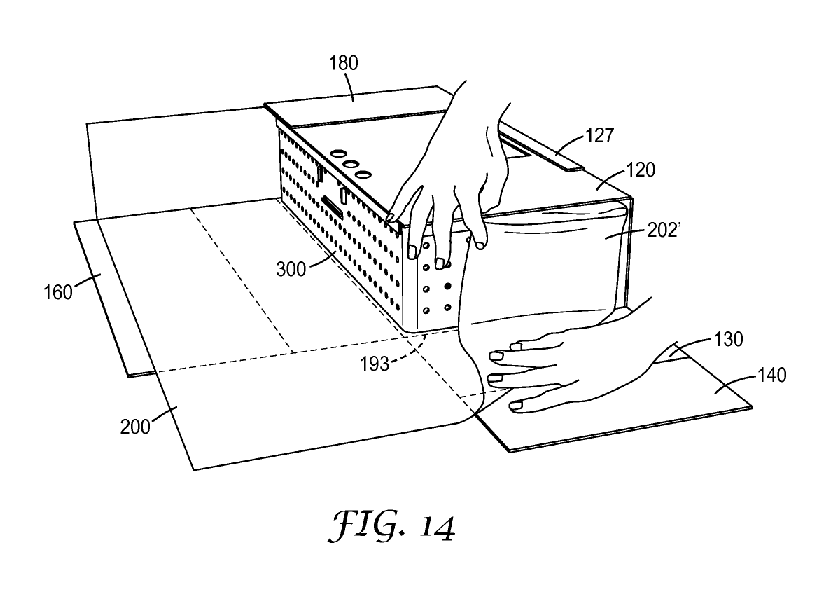

After folding the shell 10 at the eighth hinge region as described above, any other sidewall panel can be moved into a first operational position by folding the foldable shell at another hinge region that joins a sidewall panel to the bottom panel. In one embodiment, the operator can make the next fold at the third hinge region. FIG. 12 shows another top perspective view of the foldable shell 10, liner 200, and tray 300 of FIG. 11 as the operator prepares to fold the shell 10 at the third hinge region 193. Also shown in FIG. 12 are the top wall panel 120, first flap 140, the second flap 160, the third flap 180, the stop structure 127, and the excess portion 202′ of the liner 200. Optionally, the excess portion 202′ of the liner 200 can be tucked into a position adjacent a sidewall of the tray 300, as shown in FIG. 13 or as shown in FIG. 14, for example. Advantageously, this process facilitates two preferable results: 1) the liner is bent around a side edge of the tray 300 (i.e., the right front side edge of the tray shown in FIGS. 14) and 2) the excess portion 202′ is positioned so that, when the shell is folded at the third hinge region 193, at least a part of the excess portion 202′ is trapped between the second sidewall panel 130 and a sidewall (i.e., the front sidewall, as shown in FIG. 14) of the tray 300. Also shown in FIG. 13 is the fourth hinge region 194.

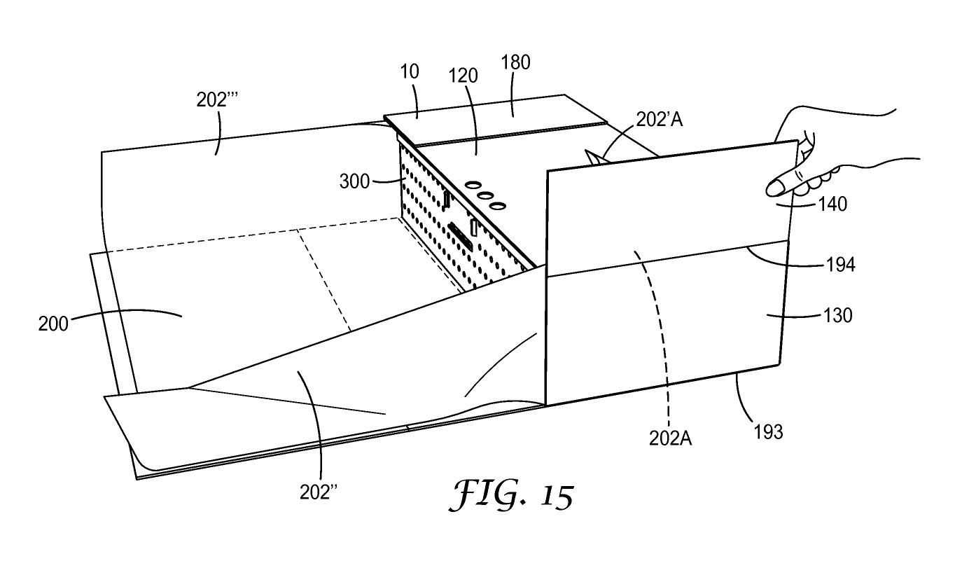

FIG. 15 shows a top perspective view of the foldable shell 10, liner 200, and tray 300 of FIG. 14 after the shell 10 is folded at the third hinge region 193 to move the second sidewall panel 130 into a first operational position. In this position, the second sidewall panel 130 is adjacent a sidewall (i.e., the front sidewall of the tray in FIG. 15) of the tray 300. It can be seen that, when the shell 10 is folded at fourth hinge region 194 to move the first flap 140 into a first operational position, a part 202′A of the excess portion of the liner 200 is entrapped between the first flap 140 and the top wall panel 120. Advantageously, this helps further secure the liner 200 in the foldable shell without the need for any additional secural means (e.g., adhesive tape) to secure the liner 200. Also shown in FIG. 15 is excess portion 202A′ of the liner 200.

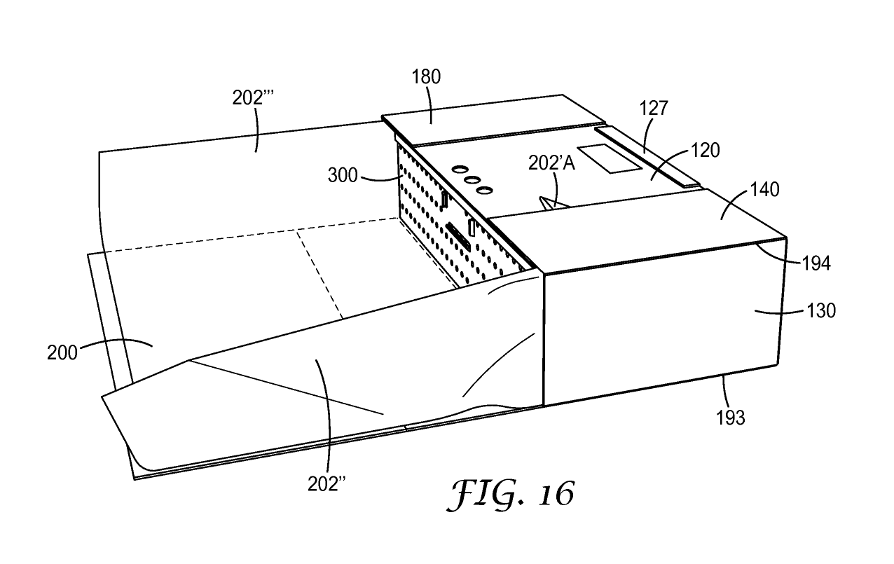

FIG. 16 shows a top perspective view of the foldable shell 10, liner 200, and tray 300 of FIG. 15 after the shell 10 is folded at the fourth hinge region 194 to move the first flap 140 into a first operational position. The first flap 140 abuts the stop structure 127, thereby hindering further movement at the third hinge region 193. A part 202′A of the excess portion of the liner 200 is entrapped between the first flap 140 and the top wall panel 120, as described above. Also shown in FIG. 16 are excess portions 202″ and 202′″ of liner 200.

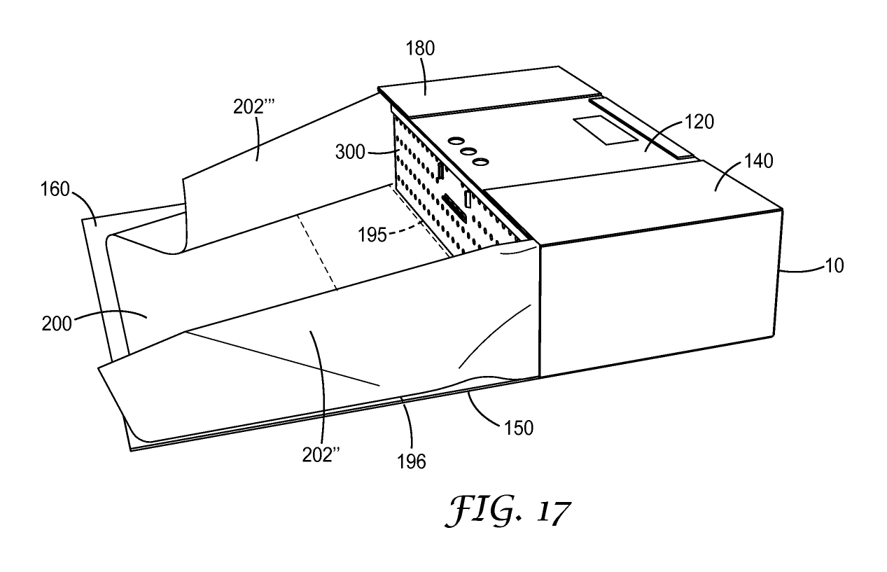

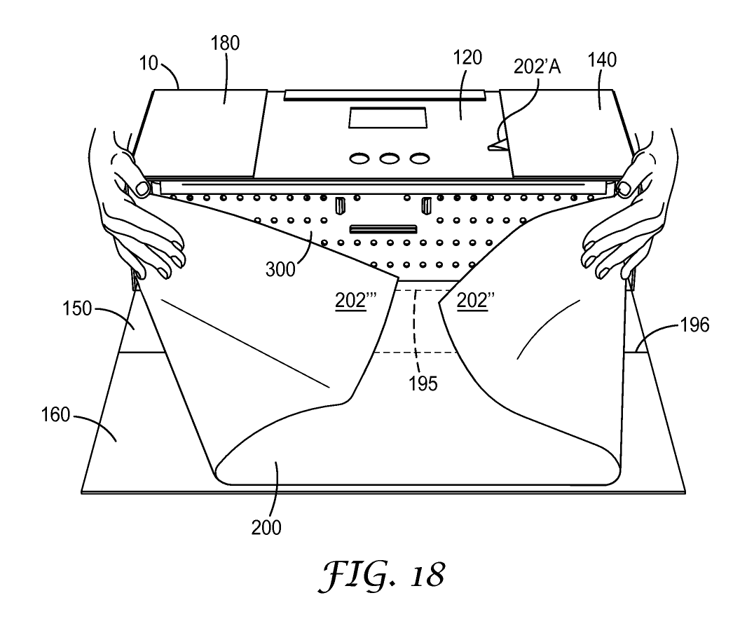

After folding the first flap 140 into a first operational position, the operator can complete the process of forming the first folded state of the shell 10 by folding the shell at the fifth hinge region 195 to move the remaining sidewall panel (third sidewall panel 150) into a first operational position and fold the shell at the sixth hinge region 196 to move the remaining flap (second flap 160) into a first operational position. FIGS. 17 and 18 show top perspective views of the foldable shell 10, liner 200, and tray 300 of FIG. 16. Optionally, prior to folding the shell 10 at the fifth hinge region 195 and/or sixth hinge region 196, one or both of the excess portions 202″ and 202′″ of the liner can be tucked into a position adjacent a sidewall of the tray 300, as shown with excess portion 202′″ in FIG. 17. Advantageously, this process facilitates two preferable results: 1) the liner is bent around a side edge of the tray 300 (i.e., the left front side edge and the right front side edge of the tray shown in FIGS. 18) and 2) the excess portions 202″ and 202′″ are positioned so that, when the shell is folded at the fifth hinge region 195, at least a part of the excess portions 202″ and 202′″ are trapped between the third sidewall panel 150 and a sidewall (i.e., the left sidewall, as shown in FIG. 17) of the tray 300. Also shown are the top wall panel 120, the first flap 140, the second flap 160, and the third flap 180.

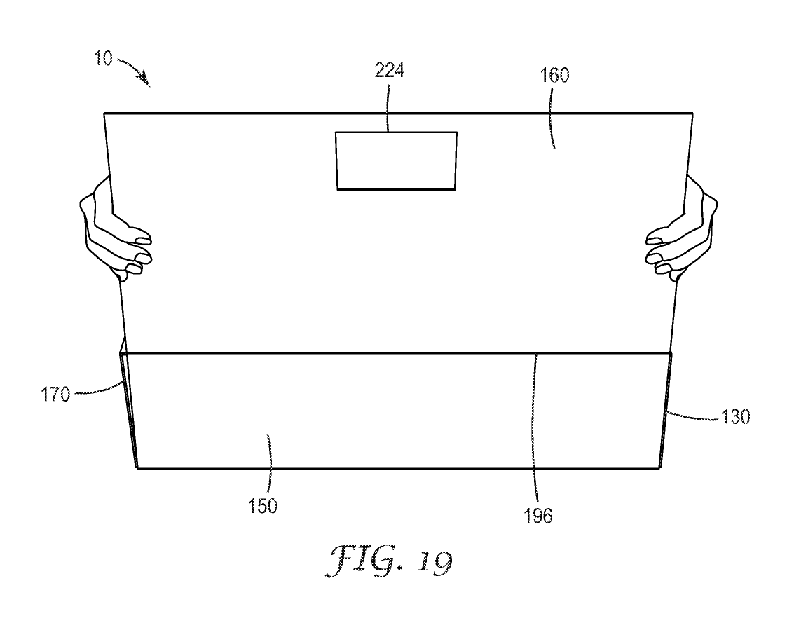

FIG. 19 shows a rear view of the foldable tray 10 of FIG. 18 after the shell 10 was folded at the fifth hinge region (not shown). Folding the shell 10 at the fifth hinge region places the third sidewall panel (not shown) into a first operational position (i.e., a vertical position) adjacent a sidewall of the tray (not shown). In this configuration, the foldable shell 10 is positioned to make the final fold at the sixth hinge region 196 to form the first folded state of the shell 10. Also shown in FIG. 19 are the second sidewall panel 130, the third sidewall panel 150, the fourth sidewall panel 170 and the second window 224.

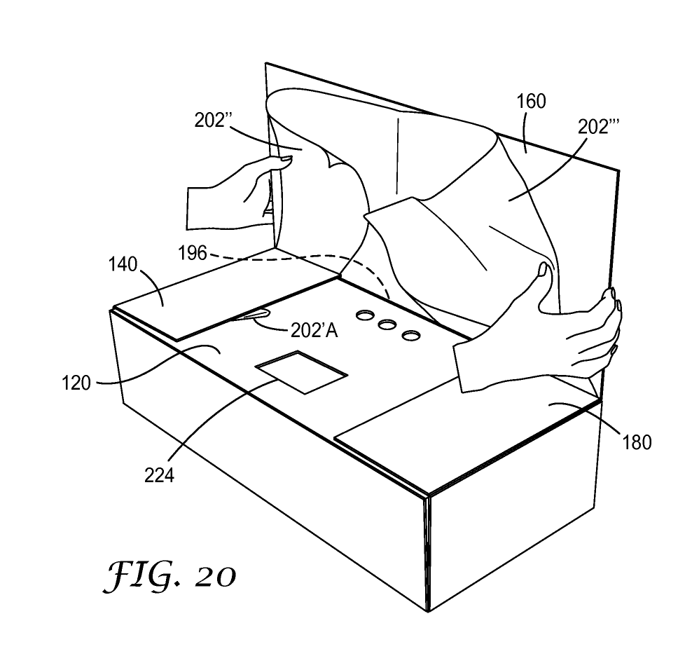

FIG. 20 shows a front perspective view of the foldable shell 10 of FIG. 19 prior to the final fold of the shell 10 at the sixth hinge region 196 to form the first folded state of the shell 10. Prior to folding the shell at the sixth hinge region 196, the operator can tuck the excess portions 202″ and 202′″ proximate the second flap 160 as shown in FIG. 20. Advantageously, this helps secure the liner 200 inside the container formed by the foldable shell 10 without the need for any additional secural means (e.g., adhesive tape) to secure the liner 200. In addition, this prevents any excess liner 200 material from projecting outside the container formed by the foldable shell 10 and getting contaminated and/or becoming snagged by a surface external to the container. Also shown in FIG. 20 are the top wall panel 120 with the first window 222, the first flap 140, and the third flap 180.

In the illustrated embodiment, folding the shell at the sixth hinge region places the shell into the first folded state, thereby forming a container that holds an object (e.g., the tray) wrapped by the liner. FIG. 21 shows a top perspective view of the container 10′ according to the present disclosure. Each of the first flap 140, second flap 160, and third flap 180 of the container 10′ overlaps at least a portion of the top wall panel 120. As discussed above, these overlaps each function to secure any excess portion of the liner between the respective flap and the top wall panel 120. Thus, the upper portion of the container 10′ has a laminate structure comprising the top wall panel 120, a portion of which is overplayed by each of the first, second, and third flaps. Although the illustrated embodiment of FIG. 21 shows the second flap 160 overlapping at least a portion of each of the first flap 140 and third flap 180, this condition is not a requirement of the container 10′ of the present disclosure.

In some embodiments, after the container 10′ of FIG. 21 is formed, at least one of the flaps (e.g., the second flap 160) is secured to another portion (e.g., at least one side panel) of the container 10′ using, for example, an adhesive tape (not shown); preferably, an adhesive tape comprising an indicator (e.g., autoclave tape) to indicate when the container has been exposed to a sterilization process. Typically, the edges of the panels are urged together to minimize any gaps (e.g., gap “A”, shown in FIG. 21) along an edge of the container 10′. However, this is not required and gap “A” illustrates that, using the method of the present disclosure, the liner provides a barrier along the edges of the container to prevent direct access by a microorganism from a location outside the container to the object inside the container.

In any embodiment, the two or more of the panels and/or flaps may comprise complementary latching means (e.g., pins and holes) to detachably hold the panels and/or flaps in a substantially fixed position relative to each other.

In any embodiment, any hinge region, panel or flap; or any combination of two or more hinge regions, panels or flaps of the container of the present disclosure may comprise a biasing means (not shown) to urge a flap or a panel in a particular direction (e.g., toward or away from) another flap or panel to which it is foldably connected. Such biasing means are known in the art and include, for example, springs. Advantageously, such biasing means can facilitate folding and/or unfolding the container.

The foldable shell of the present disclosure also can be placed into a second folded state or a third folded state for handling and storage. Both the second folded state and the third folded state are substantially planar and comprise a smaller surface area than the substantially planar unfolded state of the foldable shell. FIG. 22 shows a top perspective view of one embodiment of the shell 10″ in a second folded state. By comparing FIG. 4 to FIG. 22, it can be seen that the shell 10 is folded at the third hinge region 193 and the seventh hinge region 197 causing the second sidewall panel 130, the first flap 140, the fourth sidewall panel 170, and the third flap 180 to overlay the bottom panel 100. In this configuration, the shell 10″ is more compact for easy handling, transportation, and/or storage. Also shown in FIG. 22 are the first sidewall panel 110, top wall panel 120, third sidewall panel 150, second flap 160, second hinge region 192, and sixth hinge region 196.

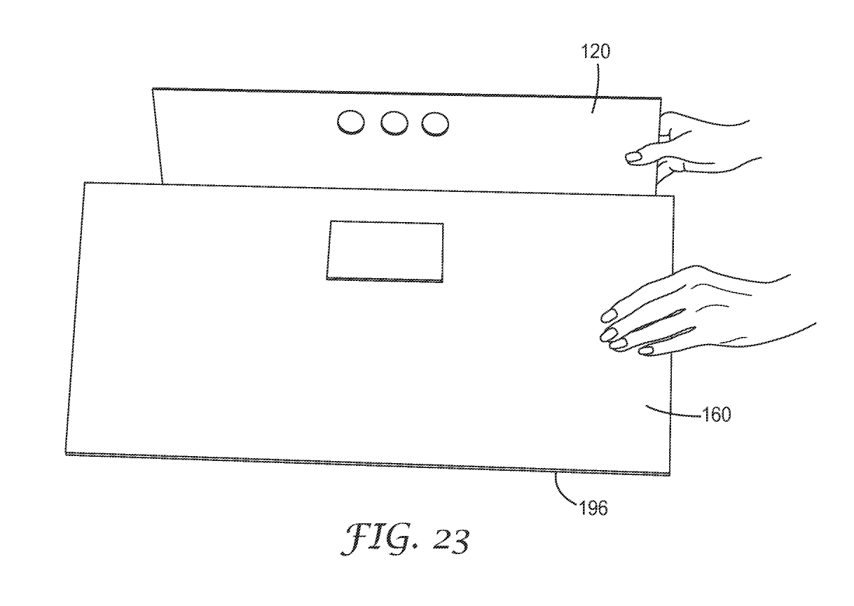

To place the foldable shell of the present disclosure into the third folded state, the shell 10″ of FIG. 22 can be folded at the second hinge region 192 and the sixth hinge region 196, as shown in FIG. 23. Completion of the folds will place the top wall panel 120 and the second flap 160 in a position (not shown) where they overlap the panels and flaps that overlap the bottom panel 100 in FIG. 22. This configuration of the shell is even more compact than the second folded state of the shell for even easier handling, transportation, and storage.

In any embodiment, an article of the present disclosure may comprise a foldable shell wherein at least one panel and/or at least one flap further comprises means for permitting fluid flow there through. The means may comprise an opening (e.g., a through-hole) or a plurality of openings. In any embodiment comprising a plurality of through-holes in a panel or a flap, the through-holes may be spaced-apart in a configuration that permits the flow of a fluid stream (e.g., water or steam) to pass through the panel or flap and contact any objects disposed in a container formed from the foldable shell. Advantageously, this feature permits an operator simultaneously to wash a container formed from the foldable shell and an object disposed in the container. Preferably, the shell is constructed from a material (e.g., metal) that, even having a plurality of through-holes, remains self-supporting.

FIG. 24 shows one embodiment of a foldable shell comprising a plurality of panels and flaps, each panel and each flap comprising at least one means for permitting fluid flow there through. In the illustrated embodiment, the foldable shell 1010 comprises a bottom panel 1100 and at least three sidewall panels (sidewall panels 1110, 1130, 1150, and 1170, respectively) and top wall panel 1120. The foldable shell 1010 further comprises at least one flap (flaps 1140, 1160, and 1180, respectively). Each of the respective wall panels and flaps comprises a plurality of means for permitting fluid flow there through (openings 1124). Also shown in FIG. 24 are the handle 1236, which is an opening in flap 1120 that is configured for grasping (e.g., shaped and dimensioned to be grasped by a hand) and a tray 300, which is disposed on the bottom panel 1100 and is partially enclosed by the foldable shell 1010. Optionally, the bottom panel may comprise means for fluid flow there through (not shown). Advantageously, the means for fluid flow permit an operator (or machine) to direct a stream (e.g., a spray) of a cleaning solvent (e.g., hot water, steam) at the assembled container (not shown), with the stream passing through the foldable shell 1010 to the object (e.g., tray 300) disposed therein. FIG. 24 shows that, even if a flap (e.g., flap 1140) overlaps another flap (top wall panel 1120), the means for permitting fluid flow (e.g., openings 1124) can be configured to permit at least partially-unobstructed fluid flow against the object (tray 300) disposed there behind.

The present disclosure provides a method of preparing an object to be sterilized, as described above. In any embodiment, the method further comprises positioning a spacer element between the object to be sterilized; or a tray, if present; and at least one panel or flap of the container. The spacer element is shaped and dimensioned to fill at least a portion of void space, if any, between the container formed by folding the foldable shell of the present disclosure and an object disposed in the container. The spacer element can help support one or more walls during and/or after the formation of the container from the foldable shell. In addition, the spacer element can prevent excessive movement of the object inside the container after the container is formed.

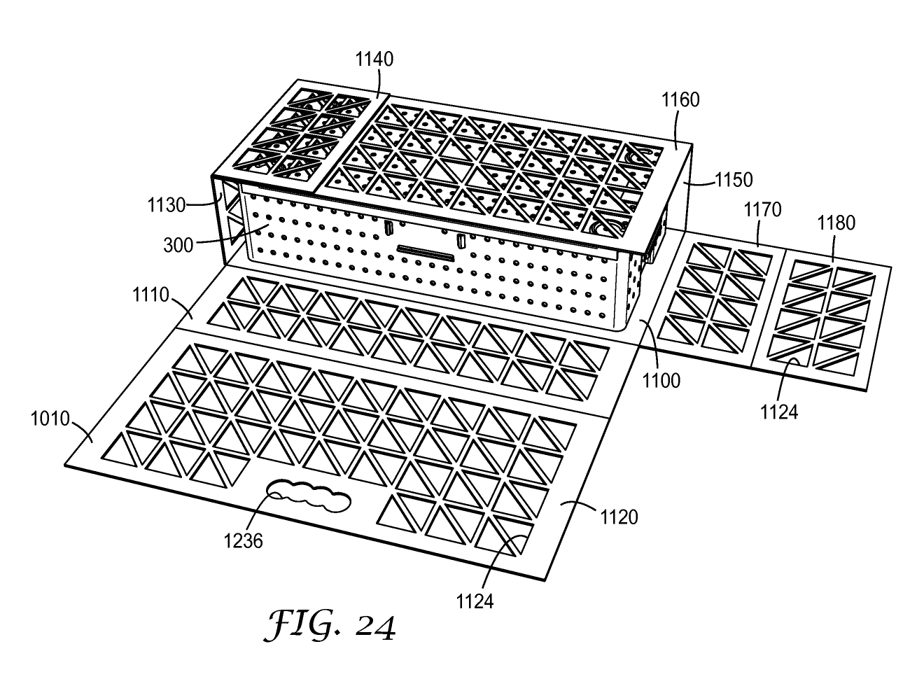

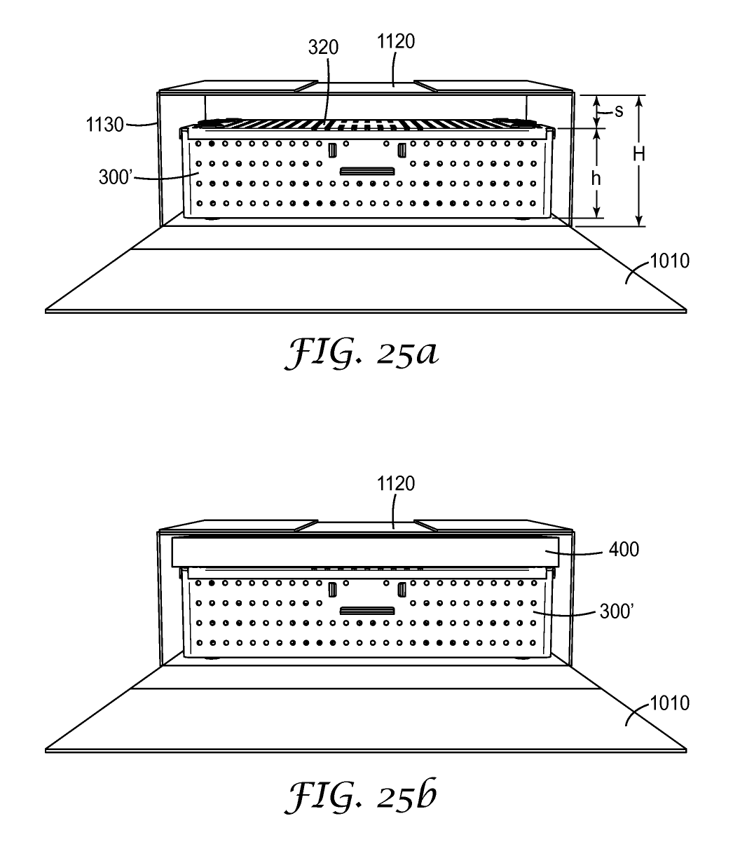

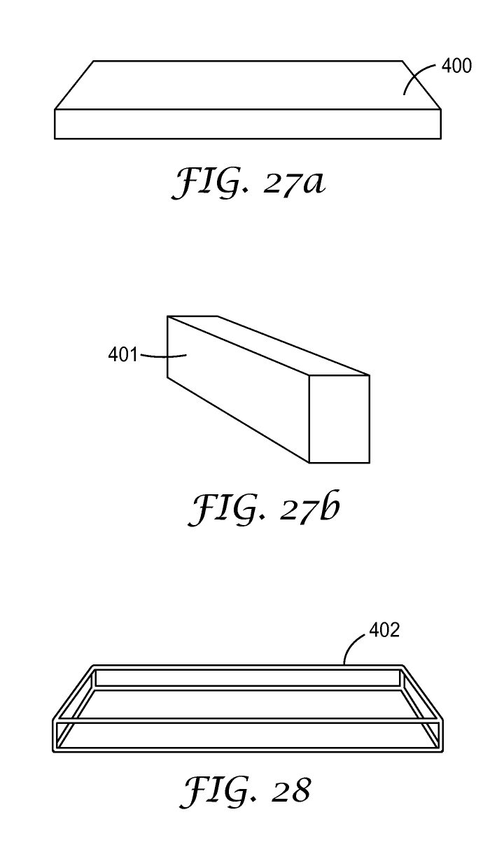

An example of the use of a spacer element is shown in FIGS. 25a and 25b. FIG. 25a shows a perspective view of the foldable shell 1010 of FIG. 24 in a partially folded state. The partially-folded foldable shell 1010 has an undersized tray 300′ disposed therein. It is noted that the height (h) of the tray 300′ is less than the height (H) of the side wall 1130 of the foldable shell 1010, leaving a void space (s) between the upper surface 320 of the tray 300′ and the top panel 1120 of the foldable shell. In an embodiment of the method, a spacer element 400 can be disposed on the upper surface 320 of the tray 300′ before or during the formation of the container using the foldable shell 1010, as shown in FIG. 25b, in order to fill or partially fill the void space (s) located above the object (tray 300′) disposed in the container 1010. The spacer element 400 is shaped and dimensioned to substantially fill the void space (s) of FIG. 25a. FIG. 27a shows a top perspective view of the spacer element 400 of FIG. 25b.

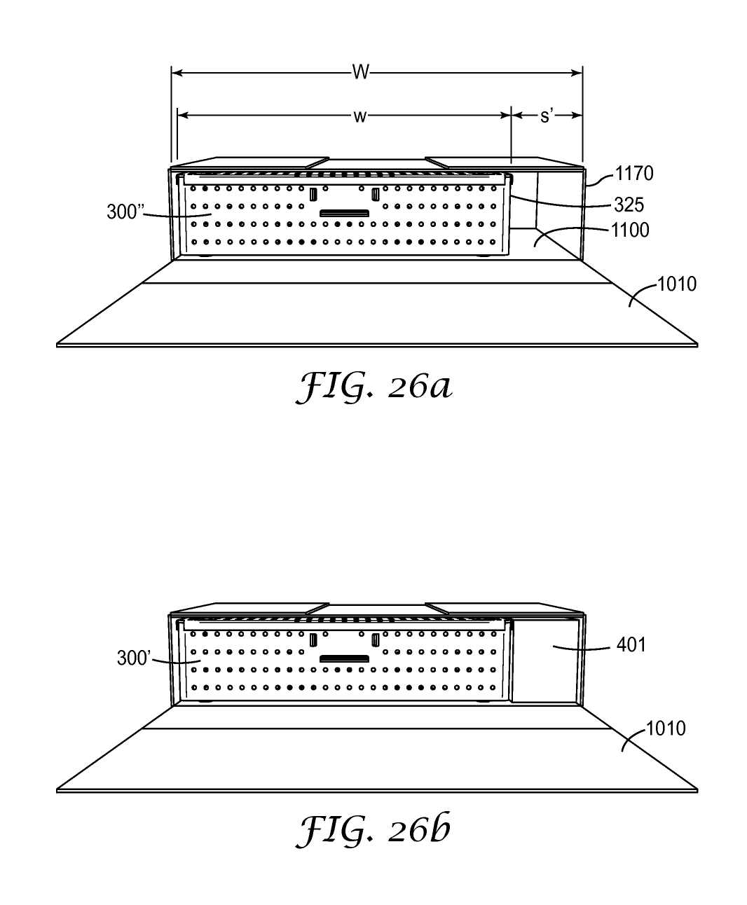

Another example of the use of a spacer element is shown in FIGS. 26a and 26b. FIG. 26a shows a perspective view of the foldable shell 1010 of FIG. 24 in a partially folded state. The partially-folded foldable shell 1010 has an undersized tray 300″ disposed therein. It is noted that the width (w) of the tray 300″ is less than the width (W) of the bottom wall 1100 of the foldable shell 1010, leaving a void space (s′) between the right edge 325 of the tray 300″ and the sidewall panel 1170 of the foldable shell 1010. In an embodiment of the method, a spacer element 401 can be disposed proximate the right edge 325 of the tray 300″ before or during the formation of the container using the foldable shell 1010, as shown in FIG. 27b, in order to fill or partially fill a void space located above the object disposed in the container. FIG. 27b shows a top perspective view of the spacer element 401 of FIG. 26b.

Spacer elements (e.g., spacer elements 400 and 401 discussed above) can be fabricated from any material that is not substantially degraded by the sterilization process in which it is used. Examples of suitable materials include, but are not limited to, polymeric materials (e.g., polycarbonate, polyethylene, polypropylene), glass, and metal. The spacer element can be formed as a solid object, a substantially hollow object with a solid exterior surface, or can be formed as a skeletal structure (e.g., an open, substantially hollow structure) that defines the space-filling boundaries. One example of a skeletal spacer element is the spacer element 402 shown in FIG. 28. It is contemplated that a spacer element can be formed and configured to fill any three-dimensional space (e.g., rectilinear three-dimensional spaces, curvilinear three-dimensional spaces, or irregular three-dimensional spaces).

In another aspect, the present disclosure provides a kit. The kit comprises any embodiment of the article comprising a foldable shell described herein. In any embodiment, the kit further comprises a tray as disclosed herein, a liner as disclosed herein, a spacer element as disclosed herein or a combination of any two or more of the foregoing. In any embodiment of the kit, the foldable shell and/or the liner may comprise attachment means so that the liner can be attached to the foldable shell as described herein.

In another aspect, the present disclosure provides a sterilization packaging system. The sterilization packaging system includes an article comprising a foldable shell according to any of the embodiments disclosed herein. The packaging system further comprises a liner that is substantially impermeable to microorganisms. In any embodiment of the system, the foldable shell and/or the liner may comprise attachment means so that the liner can be attached to the foldable shell as described herein. Preferably, the liner is shaped and dimensioned so that, when the liner and an object to be sterilized are placed on the foldable shell and the shell is folded as described herein, the object will be enclosed by both the shell and the liner when the folding process is complete. Accordingly, in the unfolded state, the bottom panel and the at least three sidewall panels of the foldable shell collectively define a first area and, according to a preferred embodiment of the sterilization packaging system, the liner is shaped and dimensioned to define a second area in which the first area fits.

In any of the above embodiments, the container further can comprise a means for securing (e.g., releasably securing) the liner to the container. The means may comprise a clamp (e.g., a spring clip or alligator clip), a hook, an entanglement device, an adhesive, hook and loop, or the like. Referring to FIG. 18, the means (not shown) could be positioned proximate the center of second flap 160, for example. In these embodiments, the liner 200 could be releasably attached to the means (not shown) when the liner is positioned on the foldable shell (as illustrated in FIG. 6). Advantageously, in these embodiments, when the foldable shell is opened (e.g., after sterilization of an object contained in the tray 300 therein), the liner is simultaneously separated from the object (or tray) with the foldable shell, thus reducing the need for handling the liner and thereby also reducing the probability of contaminating the sterilized object.

### Exemplary Embodiments

Embodiment A is a method, comprising:

positioning a liner that is substantially impermeable to microorganisms on a foldable shell;
wherein the foldable shell has an unfolded state and a first folded state that defines a container, the container defining an inner volume having a first 3-dimensional shape;
wherein the foldable shell comprises a plurality of panels that includes a bottom panel and three or more sidewall panels, the three or more sidewall panels each being hingedly connected to the bottom panel;
wherein positioning the liner comprises positioning the liner so that the liner superimposes the bottom panel;

placing an object onto a portion of the liner that superimposes the bottom panel;
wherein the object has an exterior surface that defines a second 3-dimensional shape that can be wholly contained within the first 3-dimensional shape; and

forming the container by folding the shell at a plurality of predetermined fold loci, wherein folding the shell causes the object to be enveloped by the container and the liner.

Embodiment B is the method of Embodiment A, wherein the foldable shell further comprises at least one flap that is hingedly connected to one of the three or more sidewall panels, wherein forming the container comprises positioning the at least one flap so that it superimposes a portion of one of the plurality of panels.

Embodiment C is the method of Embodiment A or Embodiment B, wherein the bottom panel has a bottom panel area circumscribed by a bottom panel first edge, a bottom panel second edge, a bottom panel third edge, and a bottom panel fourth edge;

wherein the three or more sidewall panels comprise:
a first sidewall panel having a first sidewall panel area circumscribed by a first sidewall panel first edge, a first sidewall panel second edge, a first sidewall panel third edge, and a first sidewall panel fourth edge, wherein the first sidewall panel first edge is foldably connected to the bottom panel first edge at a first hinge region, wherein the first sidewall panel third edge is foldably connected to a top wall panel at a second hinge region;
a second sidewall panel having a second sidewall panel area circumscribed by a second sidewall panel first edge, a second sidewall panel second edge, a second sidewall panel third edge, and a second sidewall panel fourth edge, wherein the second sidewall panel first edge is foldably connected to the bottom panel second edge at a third hinge region, wherein the second sidewall panel third edge is foldably connected to a first flap at a fourth hinge region;
a third sidewall panel having a third sidewall panel area circumscribed by a third sidewall panel first edge, a third sidewall panel second edge, a third sidewall panel third edge, and a third sidewall panel fourth edge, wherein the third sidewall panel first edge is foldably connected to the bottom panel third edge at a fifth hinge region, wherein the third sidewall panel third edge is foldably connected to a second flap at a sixth hinge region;
a fourth sidewall panel having a fourth sidewall panel area circumscribed by a fourth sidewall panel first edge, a fourth sidewall panel second edge, a fourth sidewall panel third edge, and a fourth sidewall panel fourth edge, wherein the fourth sidewall panel first edge is foldably connected to the bottom panel fourth edge at a seventh hinge region, wherein the fourth sidewall panel third edge is foldably connected to a third flap at an eighth hinge region;

wherein forming the container comprises sequentially folding the shell at each of the first through eighth hinge regions to form the container with the object enclosed therein;

wherein, after forming the container, a portion of the top wall panel is positioned between the first flap and the object, a portion of the top wall panel is positioned between the second flap and the object, and a portion of the top wall panel is positioned between the third flap and the object.

Embodiment D is the method of any one of Embodiments A through C, wherein folding the shell comprises folding the shell according to a predetermined sequence of folding steps.

Embodiment E is the method of Embodiment D, as dependent upon Embodiment C, wherein the shell is folded at the first and second hinge regions before the shell is folded at the third and fourth hinge regions.

Embodiment F is the method of Embodiment D, as dependent upon Embodiment C, wherein the shell is folded at the first and second hinge regions before the shell is folded at the fifth and sixth hinge regions.

Embodiment G is the method of Embodiment D, as dependent upon Embodiment C, wherein the shell is folded at the first and second hinge regions before the shell is folded at the seventh and eighth hinge regions.

Embodiment H is the method of Embodiment D, as dependent upon Embodiment C, wherein the shell is folded at the first and second hinge regions before the shell is folded at the third, fourth, fifth, sixth, seventh, and eighth hinge regions.

Embodiment I is the method of Embodiment C or the method of any one of Embodiments D-H as dependent upon Embodiment C, wherein folding the shell comprises entrapping a portion of the liner between two or more flaps or panels.

Embodiment J is the method of Embodiment I, wherein folding the shell at the fourth hinge region comprises entrapping a portion of the liner between the first flap, and the top wall panel.

Embodiment K is the method of Embodiment I or Embodiment J, wherein folding the shell at the sixth hinge region comprises entrapping a portion of the liner between the second flap, and the top wall panel.

Embodiment L is the method of any one of Embodiments I through K, wherein folding the shell at the eighth hinge region comprises entrapping a portion of the liner between the third flap, and the top wall panel.

Embodiment M is the method of any one of the preceding Embodiments, wherein the object is disposed in a tray; wherein the tray has a tray bottom and a plurality of tray sidewalls, the tray bottom and tray sidewalls defining a third 3-dimensional shape; wherein the second 3-dimensional shape can be wholly contained within the third 3-dimensional shape.

Embodiment N is the method of any one of the preceding Embodiments, further comprising positioning a spacer element between the object to be sterilized; or the tray, if present; and at least one panel or flap of the container.

Embodiment O is the method of Embodiment N, wherein the spacer element is shaped and dimensioned to facilitate forming the container into the first folded state.

Embodiment P is the method of any one of the preceding Embodiments, wherein forming the container further comprises securing a first panel or a first flap, if present, to a second panel or a second flap, if present.

Embodiment Q is the method of any one of the preceding Embodiments, further comprising subjecting the container with the object disposed therein to a sterilization process.

Embodiment R is the method of any one of the preceding Embodiments, further comprising:

removing the object and liner from the container;

removing the object from the liner;

reforming the container with the object and not the liner disposed therein; and exposing the reformed container to a washing process.

Embodiment S is an article comprising a foldable shell:

wherein the foldable shell has a first folded state that defines a container;

wherein the foldable shell comprises a plurality of panels that includes a bottom panel, three or more sidewall panels and at least one flap;

wherein each of the three or more sidewall panels is hingedly connected to the bottom panel;

wherein the at least one flap is hingedly connected to one of the sidewall panels;

wherein the at least one flap is configured to overlap one of the plurality of panels in the first folded state.

Embodiment T is the article of Embodiment S, wherein the foldable shell has a substantially planar unfolded state.

Embodiment U is the article Embodiment S or Embodiment T, wherein the foldable shell has a substantially planar second folded state.

Embodiment V is the article of any one of Embodiments S through U, wherein the plurality of panels consists of four sidewall panels and a top wall panel.

Embodiment W is the article of Embodiment V, wherein the container defines a rectangular parallelepiped shape.

Embodiment X is the article of Embodiment V or Embodiment W:

wherein the bottom panel has a bottom panel area circumscribed by a bottom panel first edge, a bottom panel second edge, a bottom panel third edge, and a bottom panel fourth edge;

wherein the four sidewall panels comprise:
a first sidewall panel having a first sidewall panel area circumscribed by a first sidewall panel first edge, a first sidewall panel second edge, a first sidewall panel third edge, and a first sidewall panel fourth edge, wherein the first sidewall panel first edge is foldably connected to the bottom panel first edge at a first hinge region, wherein the first sidewall panel third edge is foldably connected to the top wall panel at a second hinge region;
a second sidewall panel having a second sidewall panel area circumscribed by a second sidewall panel first edge, a second sidewall panel second edge, a second sidewall panel third edge, and a second sidewall panel fourth edge, wherein the second sidewall panel first edge is foldably connected to the bottom panel second edge at a third hinge region, wherein the second sidewall panel third edge is foldably connected to a first flap at a fourth hinge region;
a third sidewall panel having a third sidewall panel area circumscribed by a third sidewall panel first edge, a third sidewall panel second edge, a third sidewall panel third edge, and a third sidewall panel fourth edge, wherein the third sidewall panel first edge is foldably connected to the bottom panel third edge at a fifth hinge region; and

a fourth sidewall panel having a fourth sidewall panel area circumscribed by a fourth sidewall panel first edge, a fourth sidewall panel second edge, a fourth sidewall panel third edge, and a fourth sidewall panel fourth edge, wherein the fourth sidewall panel first edge is foldably connected to the bottom panel fourth edge at a seventh hinge region.

Embodiment Y is the article of Embodiment X, wherein the third sidewall panel third edge is foldably connected to a second flap at a sixth hinge region.

Embodiment Z is article of Embodiment X or Embodiment Y, wherein the fourth sidewall panel third edge is foldably connected to a third flap at an eighth hinge region.

Embodiment AA is the article of any one of Embodiments S through Z, wherein the shell comprises a self-supporting material.

Embodiment BB is the article of any one of Embodiments S through AA, wherein the shell comprises a metal, a plastic material, a ceramic material, a composite material, or a combination of any two or more of the foregoing materials.

Embodiment CC is the article of any one of Embodiments S through BB, wherein at least one panel further comprises means for permitting fluid flow there through.

Embodiment DD is the article of Embodiment CC, wherein at least one flap further comprises means for permitting fluid flow there through.

Embodiment EE is the article of Embodiment CC or Embodiment DD, wherein the means for permitting fluid flow comprises at least one opening.

Embodiment FF is the any one of Embodiments CC through EE, wherein the means for permitting fluid flow comprises a plurality of openings.

Embodiment GG is the Embodiment FF, wherein one or more opening of the plurality of openings comprises a through-hole.

Embodiment HH is the article of any one of Embodiments S through GG, wherein at least one hinge region is operationally controlled by a stop structure.

Embodiment II is the article of any one of Embodiments S through HH, with a liner attached to the foldable shell;

wherein the liner is substantially impermeable to microorganisms;

wherein, in the unfolded state, the bottom panel and the at least three sidewall panels of the foldable shell collectively define a first area;

wherein the liner is shaped and dimensioned to define a second area in which the first area fits.

Embodiment JJ is the article of Embodiment II, wherein the liner is attached to the bottom panel.

Embodiment KK is the article of Embodiment II or Embodiment JJ, wherein the liner is detachably attached to the foldable shell.

Embodiment LL is the article of Embodiment KK, wherein the liner is repositionably attached to the foldable shell.

Embodiment MM is the article of any one of Embodiments S through LL, further comprising a friction hinge.

Embodiment NN is a kit, comprising the article of any one of Embodiments S through MM.

Embodiment OO is the kit of Embodiment NN, further comprising a tray, a liner, or a spacer element.

Embodiment PP is a sterilization packaging system comprising:

an article comprising a foldable shell:
wherein the foldable shell has a first folded state that defines a container;
wherein the foldable shell comprises a plurality of panels that includes a bottom panel, three or more wall panels and at least one flap;
wherein the three or more wall panels each is hingedly connected to the bottom panel;
wherein the at least one flap is hingedly connected to one of the three or more wall panels; and

a liner that is substantially impermeable to microorganisms.

Embodiment QQ is the sterilization packaging system of Embodiment PP wherein, in the unfolded state, the bottom panel and the at least three sidewall panels of the foldable shell collectively define a first area; wherein the liner is shaped and dimensioned to define a second area in which the first area fits.

The complete disclosure of all patents, patent applications, and publications, and electronically available material cited herein are incorporated by reference. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

All headings are for the convenience of the reader and should not be used to limit the meaning of the text that follows the heading, unless so specified.

Various modifications may be made without departing from the spirit and scope of the invention. These and other embodiments are within the scope of the following claims.

What is claimed is:

1. A method comprising:
positioning a liner that is substantially impermeable to microorganisms on a foldable shell;
wherein the foldable shell has an unfolded state and a first folded state that defines a container, the container defining an inner volume having a first 3-dimensional shape;
wherein the foldable shell comprises a plurality of panels that includes a bottom panel and three or more sidewall panels, the three or more sidewall panels each being hingedly connected to the bottom panel;
wherein positioning the liner comprises positioning the liner so that the liner superimposes the bottom panel;
placing an object onto a portion of the liner that superimposes the bottom panel;
wherein the object has an exterior surface that defines a second 3-dimensional shape that can be wholly contained within the first 3-dimensional shape; and
forming the container by folding the shell at a plurality of predetermined fold loci, wherein folding the shell causes the object to be enveloped by the container and the liner.

2. The method of claim 1, wherein the foldable shell further comprises at least one flap that is hingedly connected to one of the three or more sidewall panels, wherein forming the container comprises positioning the at least one flap so that it superimposes a portion of one of the plurality of panels.

3. The method of claim 1:
wherein the bottom panel has a bottom panel area circumscribed by a bottom panel first edge, a bottom panel second edge, a bottom panel third edge, and a bottom panel fourth edge;
wherein the three or more wall panels comprise:
a first sidewall panel having a first sidewall panel area circumscribed by a first sidewall panel first edge, a first sidewall panel second edge, a first sidewall panel third edge, and a first sidewall panel fourth edge, wherein the first sidewall panel first edge is foldably connected to the bottom panel first edge at a first hinge region, wherein the first sidewall panel third edge is foldably connected to a top wall panel at a second hinge region;
a second sidewall panel having a second sidewall panel area circumscribed by a second sidewall panel first edge, a second sidewall panel second edge, a second sidewall panel third edge, and a second sidewall panel fourth edge, wherein the second sidewall panel first edge is foldably connected to the bottom panel second edge at a third hinge region, wherein the second sidewall panel third edge is foldably connected to a first flap at a fourth hinge region;
a third sidewall panel having a third sidewall panel area circumscribed by a third sidewall panel first edge, a third sidewall panel second edge, a third sidewall panel third edge, and a third sidewall panel fourth edge, wherein the third sidewall panel first edge is foldably connected to the bottom panel third edge at a fifth hinge region, wherein the third sidewall panel third edge is foldably connected to a second flap at a sixth hinge region;
a fourth sidewall panel having a fourth sidewall panel area circumscribed by a fourth sidewall panel first edge, a fourth sidewall panel second edge, a fourth sidewall panel third edge, and a fourth sidewall panel fourth edge, wherein the fourth sidewall panel first edge is foldably connected to the bottom panel fourth edge at a seventh hinge region, wherein the fourth sidewall panel third edge is foldably connected to a third flap at an eighth hinge region;
wherein forming the container comprises sequentially folding the shell at each of the first through eighth hinge regions to form the container with the object enclosed therein;
wherein, after forming the container, a portion of the top wall panel is positioned between the first flap and the object, a portion of the top wall panel is positioned between the second flap and the object, and a portion of the top wall panel is positioned between the third flap and the object.

4. The method of claim 1, wherein folding the shell comprises folding the shell according to a predetermined sequence of folding steps.

5. The method of claim 1, wherein the object is disposed in a tray; wherein the tray has a tray bottom and a plurality of tray sidewalls, the tray bottom and tray sidewalls defining a third 3-dimensional shape; wherein the second 3-dimensional shape can be wholly contained within the third 3-dimensional shape.

6. The method of claim 1, further comprising positioning a spacer element between the object to be sterilized; or the tray, if present; and at least one panel or flap of the container.

7. The method of claim 1, wherein forming the container further comprises securing a first panel or a first flap, if present, to a second panel or a second flap, if present.

8. The method of claim 1, further comprising subjecting the container with the object disposed therein to a sterilization process.

9. The method of claim 8, further comprising:
removing the object and liner from the container;
removing the object from the liner;
reforming the container with the object and not the liner disposed therein; and
exposing the reformed container to a washing process.

10. An article comprising a foldable shell:
wherein the foldable shell has a first folded state that defines a container;
wherein the foldable shell comprises a plurality of panels that includes a bottom panel, three or more wall panels and at least one flap;
wherein each of the three or more wall panels is hingedly connected to the bottom panel;
wherein the at least one flap is hingedly connected to one of the three or more wall panels;
wherein the at least one flap is configured to overlap one of the three or more wall panels in the first folded state.

11. The article of claim 10, wherein the foldable shell has a substantially planar unfolded state.

12. The article of claim 10, wherein the foldable shell has a substantially planar second folded state.

13. The article of claim 10, wherein the plurality of panels consists of four wall panels and a top wall panel.

14. The article of claim 13:
wherein the bottom panel has a bottom panel area circumscribed by a bottom panel first edge, a bottom panel second edge, a bottom panel third edge, and a bottom panel fourth edge;
wherein the four wall panels comprise:
a first sidewall panel having a first sidewall panel area circumscribed by a first sidewall panel first edge, a first sidewall panel second edge, a first sidewall panel third edge, and a first sidewall panel fourth edge, wherein the first sidewall panel first edge is foldably connected to the bottom panel first edge at a first hinge region, wherein the first sidewall panel third edge is foldably connected to the top wall panel at a second hinge region;
a second sidewall panel having a second sidewall panel area circumscribed by a second sidewall panel first edge, a second sidewall panel second edge, a second sidewall panel third edge, and a second sidewall panel fourth edge, wherein the second sidewall panel first edge is foldably connected to the bottom panel second edge at a third hinge region, wherein the second sidewall panel third edge is foldably connected to a first flap at a fourth hinge region;
a third sidewall panel having a third sidewall panel area circumscribed by a third sidewall panel first edge, a third sidewall panel second edge, a third sidewall panel third edge, and a third sidewall panel fourth edge, wherein the third sidewall panel first edge is foldably connected to the bottom panel third edge at a fifth hinge region; and
a fourth sidewall panel having a fourth sidewall panel area circumscribed by a fourth sidewall panel first edge, a fourth sidewall panel second edge, a fourth sidewall panel third edge, and a fourth sidewall panel fourth edge, wherein the fourth sidewall panel first edge is foldably connected to the bottom panel fourth edge at a seventh hinge region.

15. The article of claim 10, wherein the shell comprises a self-supporting material.

16. The article of claim 10, wherein the shell comprises a metal, a plastic material, a ceramic material, a composite material, or a combination of any two or more of the foregoing materials.

17. The article of claim 10, wherein at least one panel further comprises means for permitting fluid flow there through.

18. The article of claim 10, wherein at least one hinge region is operationally controlled by a stop structure.

19. The article of claim 10, with a liner attached to the foldable shell;
wherein the liner is substantially impermeable to microorganisms;
wherein, in the unfolded state, the bottom panel and the at least three sidewall panels of the foldable shell collectively define a first area;
wherein the liner is shaped and dimensioned to define a second area in which the first area fits.

20. The article of claim 10, further comprising a friction hinge.

21. A kit, comprising the article of claim 10.

22. A sterilization packaging system comprising:
an article comprising a foldable shell:
wherein the foldable shell has a first folded state that defines a container;
wherein the foldable shell comprises a plurality of panels that includes a bottom panel, three or more wall panels and at least one flap;
wherein the three or more wall panels each is hingedly connected to the bottom panel;
wherein the at least one flap is hingedly connected to one of the wall panels; and
a liner that is substantially impermeable to microorganisms.
